(19) United States
(12) Patent Application Publication
(10) Pub. No.: US 2026/0166900 A1
(43) Pub. Date: Jun. 18, 2026

(54) PRINTING APPARATUS, METHOD, AND COMPUTER-READABLE STORAGE MEDIUM

(71) Applicant: CANON KABUSHIKI KAISHA, Tokyo (JP)

(72) Inventors: SERENA SAITO, Kanagawa (JP); KEIJI KURIYAMA, Saitama (JP); FUMIHIRO GOTO, Kanagawa (JP); SATOSHI WADA, Tokyo (JP); HAJIME NAGAI, Kanagawa (JP); SHIN GENTA, Kanagawa (JP); SHINGO NISHIOKA, Kanagawa (JP); AYUMI YASUDA, Kanagawa (JP)

(21) Appl. No.: 19/407,242

(22) Filed: Dec. 3, 2025

(30) Foreign Application Priority Data
Dec. 16, 2024 (JP) 2024-220161

(51) Int. Cl. B41J 25/00; B41J 2/21; B41J 11/00

(52) U.S. Cl. CPC B41J 25/003; B41J 2/2135; B41J 11/0095

(57) ABSTRACT

A printing apparatus includes a printing unit configured to print a predetermined correction pattern as an image on a printing medium by scanning a first printing head and a second printing head, an obtainment unit configured to obtain an amount of misalignment of an ejection position of the second printing head in the rotational direction by detecting the correction pattern while scanning an optical sensor in the second direction, and a derivation unit configured to derive a correction value to correct the ejection position misalignment of the second printing head in the rotational direction with respect to the first direction based on the amount of misalignment of the ejection position of the second printing head in the rotational direction.

### BACKGROUND

### Field of the Technology

The present disclosure relates to a technique of correcting a amount of misalignment of a nozzle array of a printing head in a rotational direction (θ).

### Description of the Related Art

Conventionally, adjustment of a position of a nozzle array of a printing head in a rotational direction (θ) has been known. For example, Japanese Patent Laid-Open No. 2007-38662 (in the following, referred to as document 1) describes a technique of obtaining a θ amount of misalignment of a printing head based on a density difference due to a difference in area factors between different patterns printed by ejection from a nozzle array.

However, the printing head that ejects an ink with a small contrast, such as a transparent ink or a light ink, may fail to obtain the θ amount of misalignment of the printing head. For example, in the technique disclosed in document 1, in a case of the ink with a small contrast, the density difference due to the difference in the area factors between the patterns may not be determined, and the θ amount of misalignment of the printing head may not be obtained.

### SUMMARY

The present disclosure is directed to be able to precisely obtain a amount of misalignment of an ejection nozzle of a printing head, which ejects an ink with a small contrast, in a rotational direction (θ).

A printing apparatus according to an aspect of the present disclosure is a printing apparatus, including: a printing unit configured to print a predetermined correction pattern as an image on a printing medium by scanning a first printing head and a second printing head, the first printing head including a first nozzle array having a plurality of first nozzles ejecting a first ink, the first nozzles being arrayed in a first direction, the second print head including a second nozzle array having a plurality of second nozzles ejecting a second ink with a lower density than a density of the first ink, the second nozzles being arrayed in the first direction, the image being printed while scanning the first print head and the second print head in a second direction crossing the first direction; an obtainment unit configured to obtain an amount of misalignment of an ejection position of the second printing head in the rotational direction by detecting the correction pattern while scanning an optical sensor in the second direction; and a derivation unit configured to derive a correction value to correct the ejection position misalignment of the second printing head in the rotational direction with respect to the first direction based on the amount of misalignment of the ejection position of the second printing head in the rotational direction, wherein the printing unit prints an origin pattern by using the first nozzle array, prints a first adjustment pattern by using a first nozzle group of adjacent nozzles out of the plurality of second nozzles included in the second nozzle array, and prints a second adjustment pattern by using a second nozzle group of adjacent nozzles out of the plurality of second nozzles included in the second nozzle array, the second nozzle group is different from the first nozzle group, and based on a detection result of the correction pattern, the obtainment unit obtains the amount of misalignment of the ejection position of the second printing head in the rotational direction from a difference between a distance in the second direction between an ejection position of the first nozzle array in the origin pattern and an ejection position of the second nozzle array in the first adjustment pattern and a distance in the second direction between an ejection position of the first nozzle array in the origin pattern and an ejection position of the second nozzle array in the second adjustment pattern.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating an example of a schematic configuration of a printing apparatus according to the present embodiment;

FIG. 2 is a diagram illustrating an example of a schematic configuration of a major portion of the printing apparatus in FIG. 1;

FIG. 3A is a diagram illustrating an optical path example of an optical sensor;

FIG. 3B is a diagram illustrating an example of a detection spot of the optical sensor;

FIG. 4 is a diagram illustrating an example of an ejection orifice surface of an ink on a printing head in FIG. 2;

FIG. 5 is a block diagram describing a control system of the printing apparatus;

FIG. 6 is a diagram illustrating an ideal vertical ruled line;

FIG. 7 is a diagram illustrating an example of a case where a nozzle array in FIG. 4 is inclined;

FIG. 8 is a diagram illustrating a case where a vertical ruled line pattern extending in a Y direction is printed in a state in which θ correction of the nozzle array ejecting a color ink is performed while θ correction of the nozzle array ejecting a reactant is not performed;

FIG. 9 is a diagram illustrating a pattern in a case without inclination of the printing head;

FIG. 10A is a diagram illustrating dot arrangement in which ink droplets are dropped onto 64 small regions out of the 64 small regions;

FIG. 10B is a diagram illustrating dot arrangement in which the ink droplets are dropped onto 22 small regions out of the 64 small regions;

FIG. 10C is a diagram illustrating dot arrangement in which the ink droplets are dropped onto 48 small regions out of the 64 small regions;

FIG. 10D is a diagram illustrating dot arrangement in which the ink droplets are dropped onto 13 small regions out of the 64 small regions;

FIG. 11 is a diagram illustrating optical characteristics in a case where an origin pattern and an adjustment pattern in FIG. 9 are printed on a gloss vinyl chloride film as an example of a waterproof printing medium;

FIG. 12 is a diagram illustrating the origin pattern and the adjustment pattern on the printing medium that are printed by the printing head in FIG. 7;

FIG. 13 is a flowchart describing processing of obtaining a correction amount of the printing head according to a first embodiment;

FIG. 14 is a diagram illustrating the origin pattern and the adjustment pattern on the printing medium that are printed by the printing head according to a second embodiment;

FIG. 15 is a flowchart describing processing of obtaining the correction amount of the printing head according to the second embodiment;

FIG. 16 is a diagram illustrating the origin pattern and the adjustment pattern of the reactant on the printing medium that are printed by the printing head according to a third embodiment;

FIG. 17 is a flowchart describing processing of obtaining the correction amount of the printing head according to the third embodiment;

FIG. 18 is a diagram illustrating the origin pattern, the adjustment pattern, and a reference pattern on the printing medium that are printed by the printing head according to a fourth embodiment;

FIG. 19 is a flowchart describing processing of obtaining the correction amount of the printing head according to a fourth embodiment;

FIG. 20 is a diagram illustrating a use case in which the pattern has a low chroma;

FIG. 21 is a diagram illustrating the optical characteristics of the pattern in FIG. 20; and

FIG. 22 is a diagram illustrating the origin pattern and the adjustment pattern on the printing medium in a case where the printing head ejects a pale M ink as a correction target ink and the printing head is mounted with an inclination.

### DESCRIPTION OF THE EMBODIMENTS

In the following, preferred embodiments of the present disclosure are described in detail with reference to the appended drawings. Note that, the following embodiments are not intended to limit the matters of the present disclosure, and not all the combinations of the characteristics described in the following embodiments are necessarily required for the means for solving the problems of the present disclosure. Note that, the same constituents are denoted by the same reference numerals.

In the following descriptions, a printing apparatus using an ink jet printing method is described as an example. The printing apparatus may be, for example, a single-function printer having only a printing function or may be a multifunctional printer having multiple functions such as the printing function, a fax function, and a scanner function. Alternatively, a manufacturing apparatus that manufactures a color filter, an electronic device, an optical device, a micro structure, and the like by a predetermined printing method may be applied.

Additionally, “printing” involves not only a case of forming significant information, such as a character and a graphic, and does not matter whether it is significant or insignificant. Moreover, “printing” widely includes a case of forming an image, a design, a pattern, a structure, and the like on a printing medium or processing the medium regardless of whether it is visible to be visually sensed by a human. The “printing medium” includes not only paper used in a common printing apparatus but also widely includes something that is capable of receiving an ink such as cloth, a plastic film, a metal plate, glass, ceramics, wood material, and leather. Furthermore, the “ink” indicates a liquid that is used for “printing” regardless of whether it contains a color material.

### First Embodiment

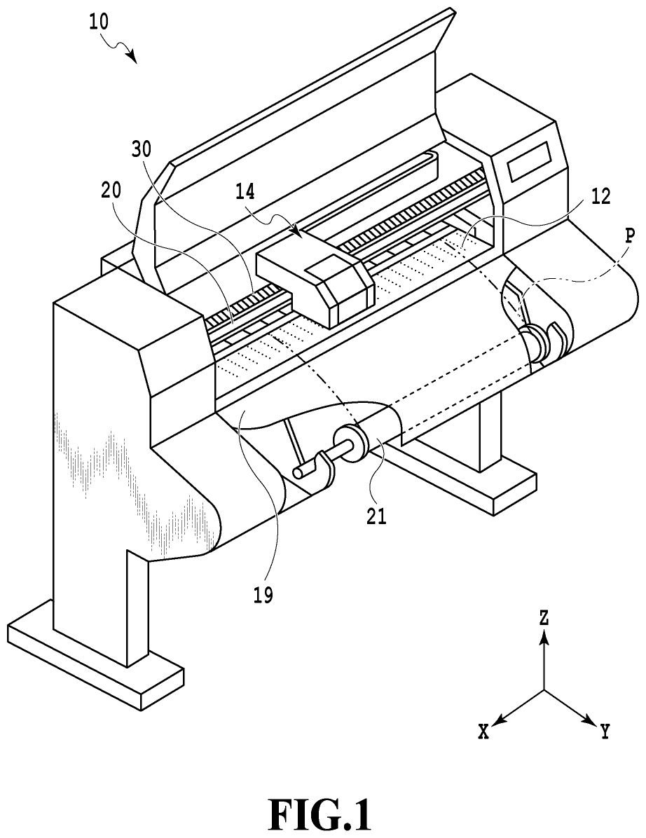

First, a printing apparatus according to a first embodiment is described with reference to FIGS. 1 to 8. The printing apparatus according to the present embodiment is a so-called serial scanning type ink jet printing apparatus, which ejects an ink from a printing head by an ink jet method onto a printing medium P being conveyed while moving the printing head in a main scanning direction crossing a conveyance direction.

### Configuration of Printing Apparatus

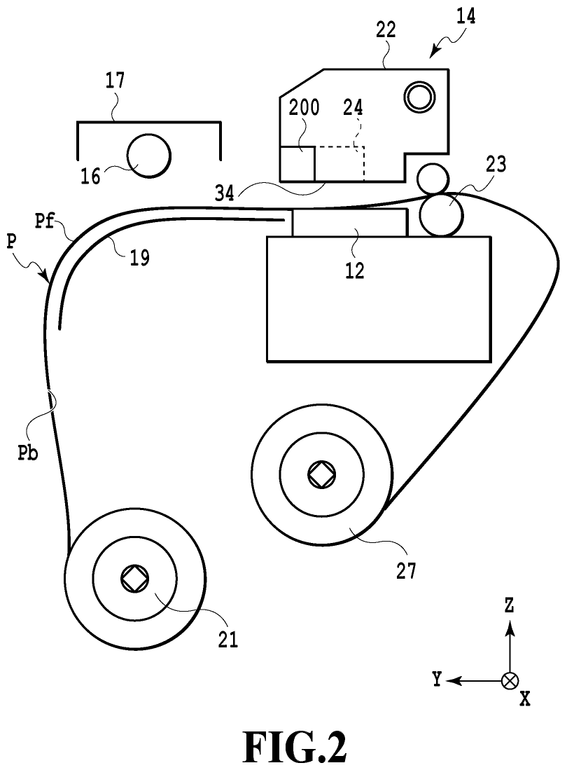

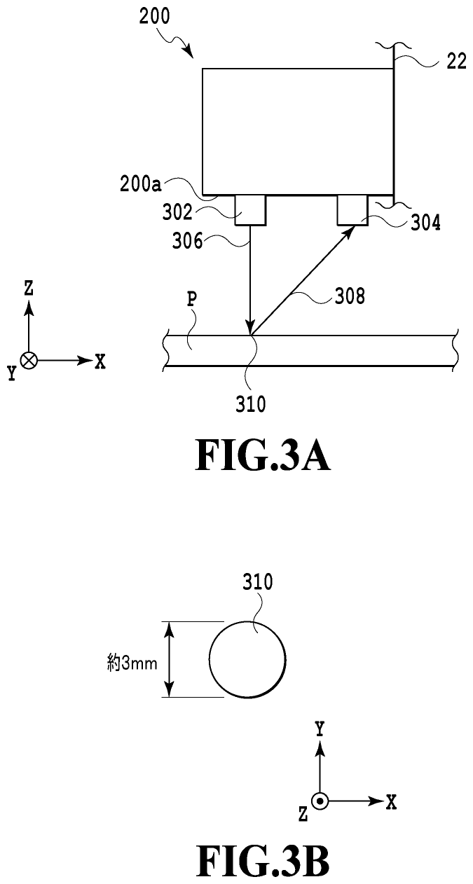

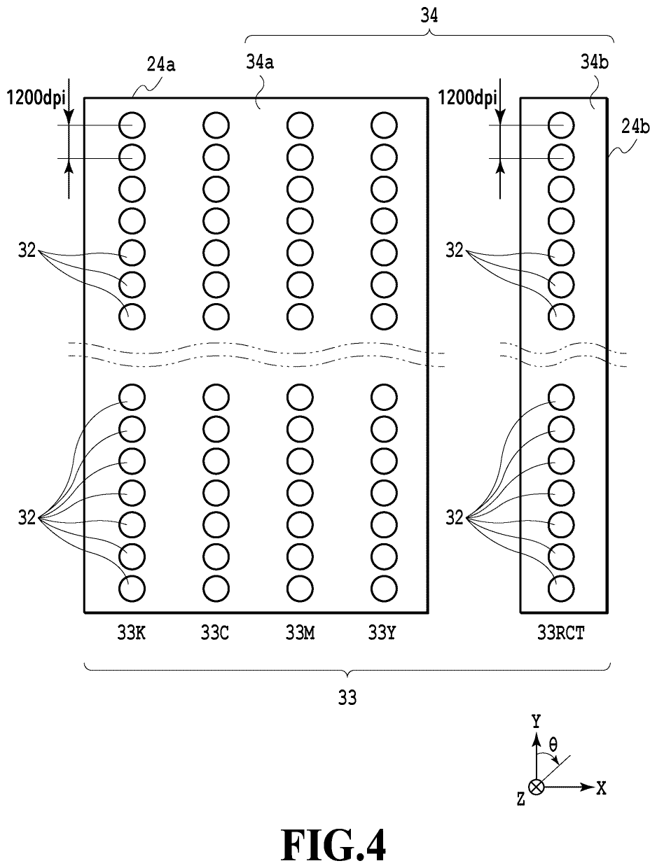

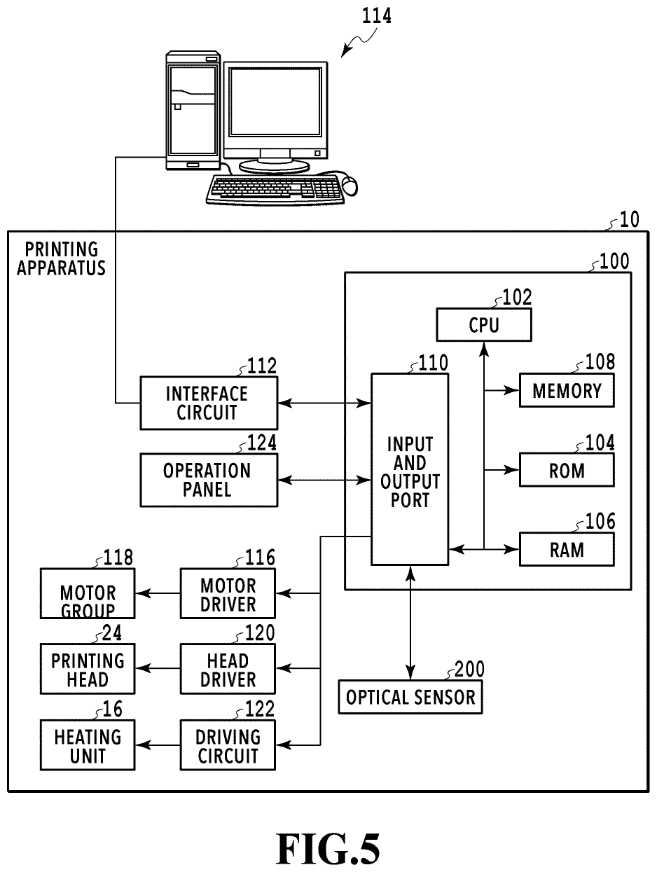

FIG. 1 is a diagram illustrating an example of a schematic configuration of a printing apparatus 10 according to the present embodiment. FIG. 2 is a diagram illustrating an example of a schematic configuration of a major portion of the printing apparatus 10 in FIG. 1. FIG. 3 is a diagram illustrating an example of a schematic configuration of an optical sensor 200 in FIG. 2. FIG. 3A is a diagram illustrating an optical path example of the optical sensor 200. FIG. 3B is a diagram illustrating an example of a detection spot of the optical sensor 200. FIG. 4 is a diagram illustrating an example of an ejection orifice surface 34 of the ink on a printing head 24 in FIG. 2. FIG. 5 is a block diagram describing a control system of the printing apparatus 10.

### Overall Configuration

As illustrated in FIG. 1, the printing apparatus 10 includes a platen 12, a printing unit 14, a guide shaft 20, a spool 21, and a linear encoder 30. As illustrated in FIG. 2, the printing apparatus 10 stores roll paper 27. The platen 12 supports the printing medium P conveyed by a conveyance unit from the roll paper 27. The conveyance unit includes a conveyance roller 23 in FIG. 2 and a motor out of a motor group 118 in FIG. 5 that corresponds to the conveyance of the printing medium P. The conveyance roller 23 is driven by the motor via a gear. The shape of the printing medium P is the form of a sheet, and as illustrated in FIG. 2, the printing medium P is stored in the printing apparatus 10 in a state of being rolled up as the roll paper 27. The printing medium P is fed by being rolled out of the roll paper 27. For example, the conveyance roller 23 conveys the printing medium P that is fed by being rolled out of the roll paper 27 to the platen 12. The printing unit 14 performs printing on the printing medium P supported by the platen 12. As illustrated in FIG. 2, the printing apparatus 10 rolls up the printing medium P after printing onto the spool 21. Note that, a conveyance mechanism of the conveyance unit is not limited thereto and may be formed by using publicly known various techniques. For example, the conveyance mechanism of the conveyance unit may include a path through which the printing medium P is flipped over so as to be able to eject the ink onto a back surface of the printing medium P. Additionally, as illustrated in FIG. 2, the printing apparatus 10 includes a heating unit 16. The heating unit 16 heats a printing surface Pf of the printing medium P after printing is performed by the printing unit 14. A guide unit 19 is provided below the heating unit 16 and on a +Y direction downstream side of the platen 12. The shape of the guide unit 19 is formed as a curve with a certain curvature toward the spool 21. According to the configuration, it is possible to convey the printing medium P to the spool 21 along the guide unit 19. Note that, overall operations of the printing apparatus 10 are controlled by a control unit 100 in FIG. 5 (described later); details are described later.

### Printing Unit 14

As illustrated in FIG. 2, the printing unit 14 includes a carriage 22 and the printing head 24. The carriage 22 is movably provided to the guide shaft 20 in FIG. 1. The guide shaft 20 is provided along an X direction crossing a Y direction in which the printing medium P is conveyed. The X direction crossing the Y direction is a direction orthogonal to the Y direction in the present embodiment. The carriage 22 is configured to be able to reciprocally move in a +X direction and a −X direction along the guide shaft 20. As illustrated in FIGS. 2 and 4, the printing head 24 includes the ejection orifice surface 34. As illustrated in FIG. 2, the printing head 24 is mounted on the carriage 22 such that the ejection orifice surface 34 is positioned to face the platen 12. Additionally, as illustrated in FIG. 4, the ejection orifice surface 34 includes multiple nozzles 32. Each nozzle 32 ejects the ink. According to the configuration of the printing apparatus 10 described above, the printing head 24 is capable of ejecting the ink while reciprocally moving in the ±X direction. Specifically, as illustrated in FIG. 4, the printing head 24 includes a printing head 24a and a printing head 24b. The printing head 24a and the printing head 24b are each mounted on the carriage 22 so as to be parallel to the Y direction at a regular interval along the X direction. Specifically, an array direction of the nozzles 32 on the printing head 24a is parallel to an array direction of the nozzles 32 on the printing head 24b. Therefore, the relationship between the printing head 24a and the printing head 24b that are parallel to each other is maintained. Note that, a specific movement mechanism of the carriage 22 is not particularly limited. For example, as the movement mechanism of the carriage 22, it is possible to use publicly known various techniques, such as a mechanism including a carriage belt and a lead screw, as a mechanism transmitting driving force from a motor corresponding to the movement of the carriage 22 out of the motor group 118 in FIG. 5.

### Linear Encoder 30

The linear encoder 30 is provided along the guide shaft 20. The position of the printing head 24 is controlled based on a position signal detected by the linear encoder 30. Additionally, the printing head 24 is configured to be able to eject the ink and a reactant. The ink contains a color material. The reactant reacts with the ink and promotes thickening and solidification of the ink, which changes the density on the printing medium P. In the present embodiment, the ink containing the color material is referred to as an ink or a color ink as needed. Additionally, in the present embodiment, it is assumed that the color ink ejected from the printing head 24 is a black ink (a K ink), a cyan ink (a C ink), a magenta ink (an M ink), and an yellow ink (a Y ink). Each of the four colors of inks is a pigment ink containing the color material expressing the corresponding color. Note that, the colors and the number of the ejected inks are not limited to the above-described four colors. For example, a particular color ink may be ejected. The particular color ink is an ink corresponding to a spot color used for a national flag and the like, for example. In addition, in a broad sense, the reactant may be treated as a type of ink.

### Operation of Printing Head 24

The printing apparatus 10 moves the printing head 24 at a speed of 45 inch/sec to perform printing at a resolution of 1200 dpi ( 1/1200 inches), for example. First, once printing is started, the printing apparatus 10 moves the printing head 24 to a printing start position and also conveys the printing medium P by the conveyance unit to a position in which the printing head 24 is able to perform printing. Next, based on printing data, the printing apparatus 10 causes the printing head 24 to perform a printing operation to eject the ink while moving (scanning) the printing head 24 in the +X direction (or the −X direction). Once the printing operation is completed, the printing apparatus 10 causes the conveyance unit to perform a conveyance operation to convey the printing medium P by a predetermined amount. Thereafter, the printing apparatus 10 causes the printing head 24 to perform the printing operation to eject the ink while moving the printing head 24 in the −X direction (or the +X direction). Thus, the printing apparatus 10 repeatedly executes the printing operation and the conveyance operation alternately. According to the operation, printing is performed on the printing medium P based on the printing data. Note that, in the present embodiment, for example, it is assumed that the printing apparatus 10 causes the printing head 24 to execute multipath printing, which is printing performed by scanning the printing head 24 multiple times, in a unit region on the printing medium P.

### Heating Unit 16

The heating unit 16 in FIG. 2 radiates heat onto the printing surface Pf of the printing medium P on which printing is performed by ejecting the ink (and the reactant) from the printing head 24 of the printing unit 14. According to the operation, the printing surface Pf and the ink ejected on the printing surface Pf are heated, and the ink is fixed on the printing surface Pf. An upper portion of the heating unit 16 is covered with a cover 17 along a Z direction. The cover 17 has a function of efficiently reflecting the heat from the heating unit 16 onto the printing medium P and a function of protecting the heating unit 16. For example, the heating unit 16 may be formed of various heaters such as a sheathed heater and a halogen heater. Instead of the contactless thermal conduction heater described above, the heating unit 16 may have a heating configuration with warm air. Note that, the heating unit 16 is not limited to the configuration to heat the printing surface Pf of the printing medium P. For example, the heating unit 16 may be provided on the +Y direction downstream side of the platen 12 and on a vertically lower side of the guide unit 19. With the above-described configuration, the heating unit 16 is provided on the vertically lower side of the guide unit 19 guiding the printing medium P after printing (a +Z direction upstream side). Therefore, the heating unit 16 arranged as described above is able to heat the printing medium P from a back surface Pb. Additionally, a heating temperature to heat the printing medium P by the heating unit 16 is set taking into consideration the fixability of the ink, the productivity of the printing medium P, and the like. In addition, multiple heating units 16 may be provided.

Note that, the ink used in the printing apparatus 10 contains a pigment, a resin fine particle, and a water-soluble organic solvent; details are described later. Accordingly, with the printing apparatus 10 heating the resin fine particle contained in the ink by the heating unit 16, the resin fine particle is melted, and also the water-soluble organic solvent in the ink is evaporated; thus, it is possible to fix the pigment on the printing medium.

The ink containing the resin fine particle has a characteristic to improve the scratch resistance (the fixability). For this reason, the heating temperature of the ink is preferably equal to or greater than the minimum film formation temperature of the resin fine particle. Additionally, most of the liquid components such as the water-soluble organic solvent in the ink needs to be evaporated during heating. Accordingly, the heating unit 16 has a configuration having a temperature distribution along the conveyance direction of the printing medium that secures the heating time to supply the energy required to evaporate most of the liquid components.

Additionally, the printing apparatus 10 may include a recovery unit (not illustrated) that maintains a good ejection state of the ink and the reactant from the nozzle 32 of the printing head 24 and performs recovery. The recovery unit is provided adjacent to the platen 12 near an end portion in the scanning direction (a movement direction) of the printing head 24. As the recovery unit, for example, a publicly known configuration such as a wiping unit that wipes the ejection orifice surface 34 and a cap protecting the ejection orifice surface 34 may be used.

### Overview of Optical Sensor 200

Next, a configuration of the optical sensor 200 is described with reference to FIG. 3. For example, the optical sensor 200 is arranged on a +X direction upstream side of the carriage 22. The optical sensor 200 detects optical characteristics of the printing medium P. For example, the optical sensor 200 is formed of a reflection type optical sensor. Based on a detection result of the optical sensor, the printing apparatus 10 is capable of detecting an optical density (OD) value as reflection optical characteristics on the printing medium P. Note that, the position in which the optical sensor 200 is installed is not limited thereto. That is, the optical sensor 200 may be provided on a +X direction downstream side of the carriage 22 or may be provided on a +Y direction downstream side. Alternatively, the optical sensor 200 may be provided independently from the carriage 22 and have a configuration movable in the X direction, or may have a configuration to be arranged along the X direction across a width of the printing medium P. Additionally, a detection device other than the optical sensor 200 described later may be used.

### Arrangement Configuration of Optical Sensor 200

Specifically, the optical sensor 200 is provided to the carriage 22 in a fixed manner such that a measurement region is positioned on a +Y direction downstream side of a nozzle array 33 of the printing head 24 in the Y direction. The nozzle array 33 is described later with reference to FIG. 4, and a lower surface 200a of the optical sensor 200 coincides with the ejection orifice surface 34 in the Z direction or is positioned on a +Z direction downstream side of the ejection orifice surface 34.

### Function of Optical Sensor 200

The optical sensor 200 includes a light emitter 302 and a light receiver 304. The light emitter 302 is formed of a visible LED of colors of red, green, blue, and the like. The light receiver 304 is formed of a photodiode. The light emitter 302 and the light receiver 304 are provided to the lower surface 200a of the optical sensor 200. The light emitter 302 emits light to the printing medium P. On the other hand, the light receiver 304 receives reflected light that is reflected from the printing medium P or a periphery of the printing medium P. Accordingly, in the optical sensor 200, light 306 emitted by the light emitter 302 is reflected to diffuse by the printing medium P, and reflected light 308 is received by the light receiver 304. A diameter of a detection spot 310 at which the light 306 emitted by the light emitter 302 is reflected to diffuse by the printing medium P is about a diameter of 3 mm, for example. A detection signal (an analog signal) of the reflected light 308 received by the light receiver 304 is transmitted to a control circuit on an electric substrate of the printing apparatus 10 via a flexible cable (not illustrated) and the like and is converted into a digital signal by an A/D converter in the control circuit. As described later, in a case of detecting the optical characteristics of an adjustment pattern, the conveyance in the Y direction of the printing medium P and the movement in the X direction of the carriage 22 to which the optical sensor 200 is attached are executed alternately. With the operation, in synchronization with a timing based on the position signal obtained by the linear encoder 30, the optical sensor 200 detects the density of a printing result (also referred to as a printed subject) printed on the printing medium P as an optical reflectivity. Thus, the printing apparatus 10 radiates the light onto each pattern of the adjustment pattern on the printing medium P to detect the reflection intensity reflecting the density of the pattern. Therefore, in a case where the printing medium P is white, the reflection intensity is great. On the other hand, the greater the density of the pattern is, the smaller the reflection intensity.

### Configuration of Printing Head

Next, a configuration of the printing head 24 is described with reference to FIG. 4. Note that, FIG. 4 is a diagram viewing the ejection orifice surface 34 in FIG. 2 from the +Z direction. Additionally, a rotational direction θ of the nozzle array 33 indicates an inclination of the nozzle array 33 with respect to a sub scanning direction. That is, the rotational direction θ of the nozzle array 33 indicates an inclination of the nozzle array 33 with respect to the +Y direction. Each of the printing head 24a and the printing head 24b is individually mounted on the carriage 22. The nozzle array 33 is formed on the ejection orifice surface 34 of the printing head 24. In the nozzle array 33, the multiple nozzles 32 ejecting the corresponding liquids are arrayed along the Y direction. Specifically, a nozzle array 33K ejecting the K ink, a nozzle array 33C ejecting the C ink, a nozzle array 33M ejecting the M ink, and a nozzle array 33Y ejecting the Y ink are formed on an ejection orifice surface 34a of the printing head 24a sequentially in the +X direction. On the other hand, a nozzle array 33RCT ejecting a reactant RCT is formed on an ejection orifice surface 34b of the printing head 24b.

As described above, the reactant RCT promotes solidification and thickening of the color ink by reacting with the color ink. Specifically, the reactant RCT contains no color material but contains a reactive component that reacts with the color material contained in the color ink. According to the above-described content configuration, the reactant RCT solidifies and thickens the color ink by being put in contact with the color ink. With the action, the reactant RCT suppresses a blur of the color ink on the printing medium P.

Note that, in the present embodiment, it is assumed that 1280 nozzles 32 are arrayed on each nozzle array 33 in the Y direction at a density of 1200 dpi. Additionally, it is assumed that an ejection amount of the liquid (the color ink and the reactant) ejected from one nozzle 32 at one time is about 4.5 pl, for example. Moreover, it is assumed that each nozzle array 33 has a configuration to be connected to a tank (not illustrated) each retaining the corresponding liquid so as to be supplied with the ink and the reactant from the tanks. Furthermore, the tank may be integrally formed with the printing head 24 or may have a configuration attachable to and detachable from the carriage 22.

### Color Ink and Reactant

Next, the color ink and the reactant used by the printing apparatus 10 are described. In the present embodiment, the printing apparatus 10 can use the pigment ink containing the pigment and a water-soluble resin fine particle ink containing no pigment or containing a small amount of pigment. The pigment ink and the water-soluble resin fine particle ink contain the water-soluble organic solvent. It is possible to add various surfactants, antifoaming agents, preservatives, fungicides, and so on to the color ink as needed so as to provide a desired characteristic according to the needs.

### Color Ink

The color ink contains the water-soluble resin fine particle that closely attaches the printing medium P and the color material to each other and improves the scratch resistance (the fixability) of the printing image. The resin fine particle is dissolved by heat, and film formation of the resin fine particle and drying of the solvent contained in the ink are performed by the heater (the heating unit 16 and the like). In the present embodiment, the resin fine particle is a polymer fine particle existing in a state of dispersing in water. Additionally, the polymer fine particle existing in a state of dispersing in water may have a form of a resin fine particle obtained by homopolymerization of a monomer having a leaving group or copolymerization of multiple types, which is a so-called self-dispersion pigment fine particle dispersion. The color ink contains a surfactant. As the surfactant, a penetrant that improves the permeability of the color ink into the dedicated printing medium P for ink jet is used. In the present embodiment, a surface tension of each color ink is equal to or smaller than 30 dyn/cm, and a difference in the surface tension between the color inks is adjusted to be within 2 dyn/cm. Specifically, the surface tension of each color ink is about 28 to 30 dyn/cm. Additionally, in terms of preventing elution of impurities from a member put in contact with the ink in a housing of the printing apparatus 10 or in the printing head 24, deterioration of material forming the member, and a reduction in the solubility of pigment dispersion resin in the ink, it is preferable for the color ink to satisfy the following conditions. That is, pH of the color ink is preferably 7.0 or greater and 10.0 or smaller. As the color ink used in the present embodiment, an anionic color material is used. Therefore, pH of each color ink is stabilized on an alkali side, and pH of each color ink is 8.5 to 9.5.

### Reactant

The reactant contains the reactive component that reacts with the pigment contained in each color ink and causes agglutination or gelatinization of the pigment. Alternatively, the reactant contains the reactive component and the like that react with resin and the like and insolubilize the pigment. For example, the reactive component is a component that can break the dispersion stability of the ink in a case of being mixed with the ink containing the target component that is stably dispersed in an aqueous vehicle by an action of an ionic group. For example, as the reactive component, organic acid such as glutaric acid may be used. Based on the total mass of the composition contained in the reactant, a content of the organic acid in the reactant is preferably 3.0% by mass or greater and 90.0% by mass or smaller and is more preferably 5.0% by mass or greater and 70.0% by mass or smaller. Additionally, as with the color ink, the surfactant is also added to the reactant.

### Control Configuration of Printing Apparatus

Next, a configuration of the control system of the printing apparatus 10 is described with reference to FIG. 5. In addition to the above description, the printing apparatus 10 also includes the control unit 100, an interface circuit 112, an operation panel 124, a motor driver 116, the motor group 118, a head driver 120, and a driving circuit 122 as a control system. Additionally, the printing apparatus 10 is connectable to an external host apparatus 114. The control unit 100 that controls overall the printing apparatus 10 includes a central processing unit (CPU) 102, a ROM 104, a RAM 106, and a memory 108. The CPU 102 performs operation control of each configuration member of the printing apparatus 10, execution of a processing program of image data, and the like based on various programs. The ROM 104 functions as a memory that stores operation control of each configuration member executed by the CPU 102, the processing program of the image data, and the like. The RAM 106 saves various data used to control the printing apparatus 10. The memory 108 stores various data such as a mask pattern and the adjustment pattern described later. Additionally, the control unit 100 includes an input and output port 110. The control unit 100 is connected to various drivers, driving circuits, and the like via the input and output port 110.

The control unit 100 is connected to the interface circuit 112 via the input and output port 110. The control unit 100 is connected to the host apparatus 114 via the interface circuit 112. Additionally, the control unit 100 is connected to the operation panel 124 via the input and output port 110. The operation panel 124 accepts an operation of a user and displays a screen according to the operation of the user. For example, the operation panel 124 is formed of a liquid crystal display including a touch panel. The user is able to input the image data to the printing apparatus 10 via the host apparatus 114 and input various types of information to the printing apparatus 10 via the host apparatus 114 and the operation panel 124. Additionally, the control unit 100 is connected to the motor driver 116 via the input and output port 110. The control unit 100 controls driving of the motor group 118 via the motor driver 116. Note that, in the example in FIG. 5, various motors in the printing apparatus 10 such as the motor that moves the carriage 22 and a motor that drives the conveyance unit conveying the printing medium P are collectively illustrated as the motor group 118.

Additionally, the control unit 100 is connected with the head driver 120 via the input and output port 110. The control unit 100 controls the printing head 24 via the head driver 120 to eject the ink. The control unit 100 is connected to the driving circuit 122 via the input and output port 110. The control unit 100 controls driving of the heating unit 16 via the driving circuit 122. In addition, the control unit 100 is connected to the optical sensor 200 via the input and output port 110. The control unit 100 controls driving of the optical sensor 200 and detects the optical characteristics of the adjustment pattern based on an output from the optical sensor 200. Thus, in the present embodiment, the control unit 100 and the optical sensor 200 function as a detection unit that is capable of detecting the optical characteristics of the printed subject printed on the printing medium P.

The CPU 102 converts the image data inputted from the host apparatus 114 into printing data and stores the printing data in the RAM 106. Specifically, the CPU 102 obtains the image data represented by information of 8-bit and 256 values for each of RGB (0 to 255). The CPU 102 executes color conversion processing to perform color conversion of the obtained image data into multi-valued data represented by multiple types of inks used for printing (in the present embodiment, K, C, M, and Y). According to the color conversion processing, the multi-valued data represented by the information of 8-bit and 256 values (0 to 255) that determines tone of each ink, which is K, C, M, or Y, in each of pixel groups including multiple pixels is generated.

Next, the CPU 102 executes quantization processing of multi-valued data represented by K, C, M, and Y. Specifically, the CPU 102 generates quantization data (binary data) represented by information of 1 bit and binary (0, 1) that determines whether or not to eject each ink of K, C, M, and Y to each pixel. As the quantization processing, publicly known various quantization methods such as an error diffusion method, a dither method, and an index method may be used. Thereafter, the CPU 102 executes distribution processing to distribute the quantization data to multiple times of scanning performed on a unit region of the printing head 24. According to the distribution processing, the printing data represented by the information of 1 bit and binary (0, 1) that determines whether or not to eject each ink of K, C, M, and Y to each pixel in each of the multiple times of scanning performed on a unit region of the printing medium P is generated. The distribution processing is executed by using the mask pattern that corresponds to the multiple times of scanning and determines whether or not to allow for the ejection of the ink to each pixel. Note that, the above-described generation of the printing data is not limited to be executed by the control unit 100 and may be executed by the host apparatus 114, or a part of the processing may be performed by the host apparatus 114, and the rest of the processing may be executed by the control unit 100.

### Obtainment Processing

In the above configuration, the printing apparatus 10 executes printing processing to perform printing on the printing medium P based on the printing data. In the printing processing, printing on a unit region on the printing medium P is performed with the printing head 24 ejecting the ink (the reactant) while moving in the X direction via the carriage 22. During the above-described printing, basically, the color ink and the reactant are each ejected in the same region by a predetermined amount. According to the operation, it is possible to obtain an effect of suppressing a blur of the ink that notably occurs particularly on the non-permeable printing medium P with the reactant being put in contact with the color ink at a constant ratio. Additionally, the printing medium P onto which the color ink and the reactant are ejected is conveyed and passes through the heating unit 16 to heat and dry the color ink. According to the operation, even in a case where the printing medium P has a property of non-permeable or poorly permeable for instance, it is possible to perform printing that promotes the fixation of the ink.

As described above, in the printing apparatus 10, it is necessary to eject the color ink and the reactant onto the same region. For this reason, the printing apparatus 10 is able to obtain a amount of misalignment of a relative ejection position of the reactant with respect to the ejection position of the color ink. In the following descriptions, “the amount of misalignment of the relative ejection position of the reactant with respect to the ejection position of the color ink” is also referred to as “the amount of misalignment of the ejection position of the reactant.”

The obtainment processing to obtain the amount of misalignment of the ejection position of the reactant is executed with the user instructing the start of the obtainment processing via the host apparatus 114, the operation panel 124, and the like, for example. Based on the amount of misalignment of the ejection position of the reactant obtained by the obtainment processing, the printing apparatus 10 obtains a correction value used to correct an ejection timing of the reactant. In addition, during the printing processing, the reactant is ejected while correcting the ejection timing of the reactant based on the obtained correction value.

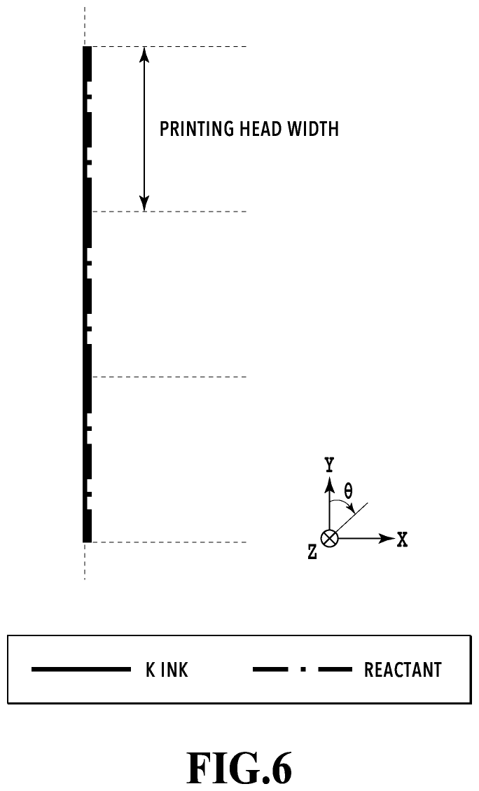

Moreover, the printing apparatus 10 is configured to be able to obtain the amount of misalignment of the ejection position in the rotational direction of the printing head 24. FIG. 4 illustrates a state in which the printing head 24 is attached ideally on the printing apparatus 10 such that an ink dot can be arranged ideally on the printing medium P. An image of the image formed on the printing medium in a case where a vertical ruled line is printed in the above-described ideal state is illustrated in FIG. 6. FIG. 6 is a diagram illustrating an ideal vertical ruled line. The ideal vertical ruled line as illustrated in FIG. 6 makes it possible to obtain a ruled line intended by the user. However, the amount of misalignment is varied individually depending on the printing head 24 and the printing apparatus 10; for this reason, arrangement of the nozzle 32 in an ideal position with respect to the printing medium P only by using hardware is unrealistic in terms of cost and technique. Additionally, because of a size reduction of the droplet of the ink dot according to the recent improvement in the image quality, demands for the ink dot landing accuracy on the printing medium P have been growing.

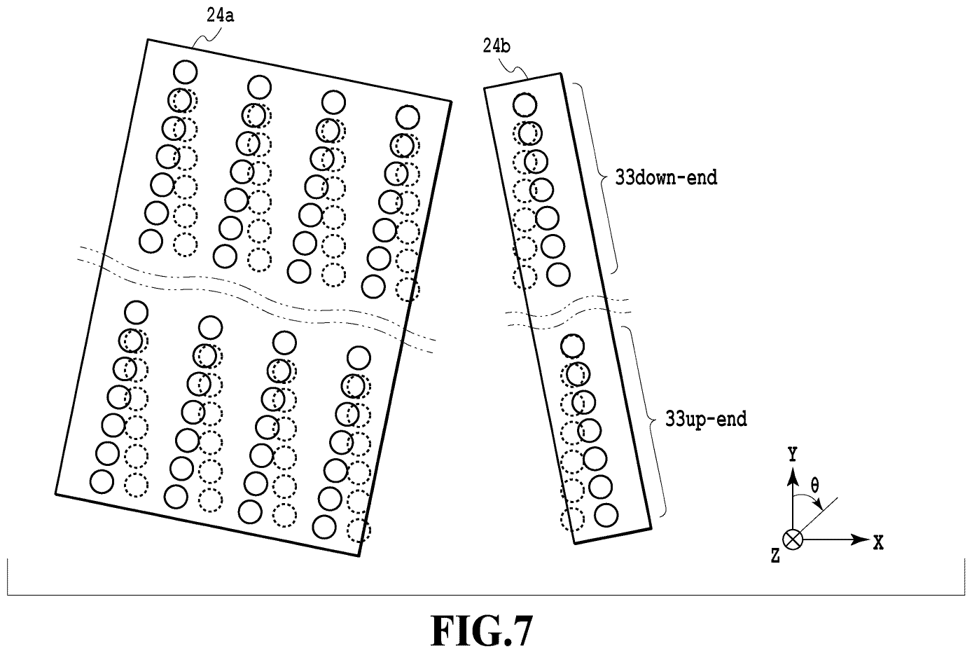

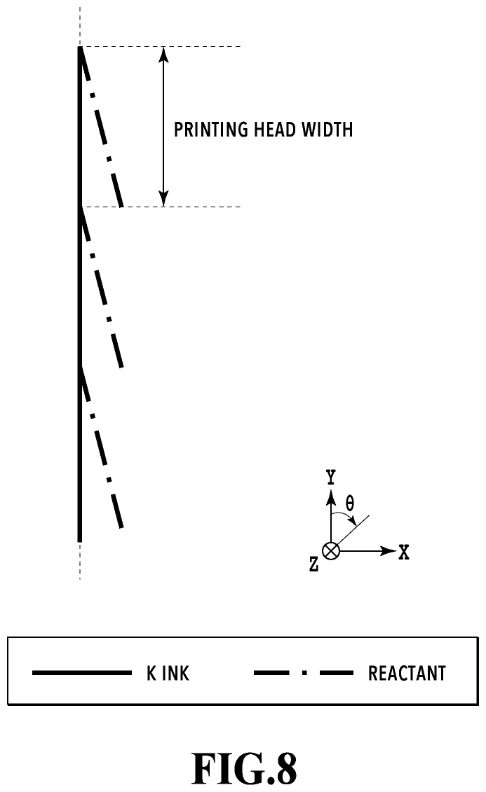

Under the above-described circumstances, there is also a case where the printing heads 24a and 24b are attached in a state as illustrated in FIG. 7. FIG. 7 is a diagram illustrating an example of a case where the nozzle array 33 in FIG. 4 is inclined. In the state in which the printing heads 24a and 24b are attached as illustrated in FIG. 7, although it is possible to correct the rotational direction of the printing head 24a ejecting the color ink (in the following, referred to as θ correction) by a publicly known technique, it is difficult to perform θ correction of the printing head 24b ejecting the reactant that basically has no color. FIG. 8 is a diagram illustrating a case where a vertical ruled line pattern extending in the Y direction is printed by the nozzle array 33K and the nozzle array 33RCT in a state in which θ correction of the nozzle array 33K is performed while θ correction of the nozzle array 33RCT is not performed. As illustrated in FIG. 8, in a case where θ correction is executed for the K ink, but θ correction of the reactant is not executed, the K ink and the reactant are not printed in the same region. Therefore, the ruled line printed with the K ink has a blur, and the image may be deteriorated. Accordingly, θ correction is also necessary for the printing head 24b ejecting the reactant.

In the following, the obtainment processing to obtain a θ correction amount of the printing head 24b executed by the printing apparatus 10 and the pattern to be adjusted by the obtainment processing are described in detail.

### Adjustment Pattern

First, the adjustment pattern used in the obtainment processing is described. Note that, the adjustment pattern described later is an example of the adjustment pattern to which the present embodiment is applicable, and it is possible to set a different adjustment pattern in light of another element as needed.

### Case Without Inclination of Printing Head 24b

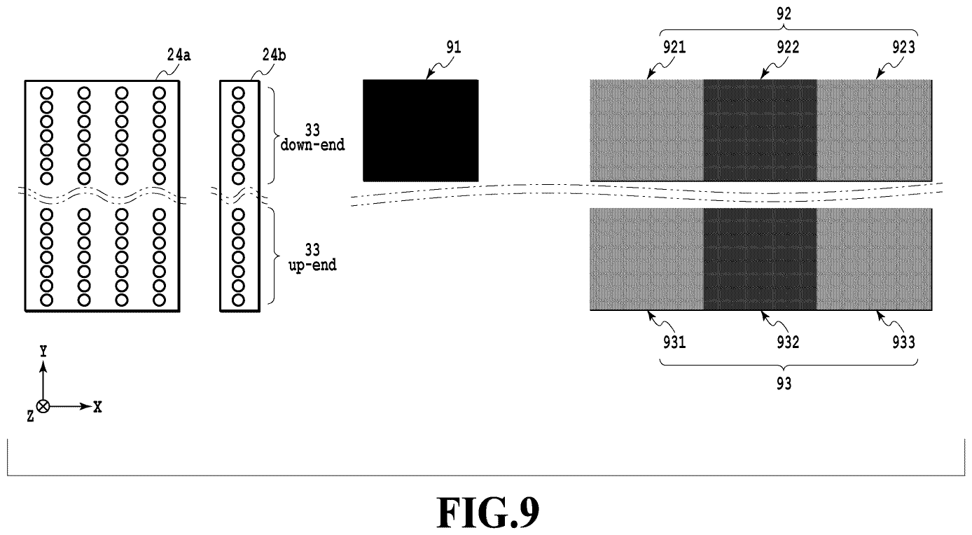

FIG. 9 is a diagram illustrating the pattern in a case without inclination of the printing heads 24a and 24b. In FIG. 9, the obtainment processing to obtain the amount of misalignment of the ejection position of the reactant by using the optical sensor 200 is executed. It is assumed that each pattern described below is printed during the obtainment processing. For example, a pattern 91 indicates an origin pattern. A pattern 92 and a pattern 93 each indicate the adjustment pattern. The pattern 92 includes a pattern 921, a pattern 922, and a pattern 923. The pattern 93 includes a pattern 931, a pattern 932, and a pattern 933. Specifically, as described with reference to FIG. 4, the multiple nozzles are arrayed on each of the printing heads 24a and 24b. In FIG. 9, some of the multiple nozzles arrayed on each of the printing heads 24a and 24b that are positioned on a downstream end portion side of each of the printing heads 24a and 24b are referred to as a nozzle group 33down-end. That is, the nozzle group 33down-end of the printing head 24a is positioned on the downstream end portion side of the printing head 24a. The nozzle group 33down-end of the printing head 24b is positioned on the downstream end portion side of the printing head 24b. Additionally, some of the multiple nozzles arrayed on each of the printing heads 24a and 24b that are positioned on an upstream end portion side of each of the printing heads 24a and 24b are referred to as a nozzle group 33up-end. That is, the nozzle group 33up-end of the printing head 24a is positioned on the upstream end portion side of the printing head 24a. The nozzle group 33up-end of the printing head 24b is positioned on the upstream end portion side of the printing head 24b. Therefore, the nozzle group 33down-end is a nozzle aggregation that is a part of the multiple nozzles. Additionally, the nozzle group 33up-end is a nozzle aggregation that is another part of the multiple nozzles. The nozzle aggregation herein is an aggregation including at least one nozzle 32 (see FIG. 4) out of the multiple nozzles 32.

The pattern 91 and the pattern 92 are printed on the printing medium P by the nozzle group 33down-end of the printing head 24a and the nozzle group 33down-end of the printing head 24b. Additionally, the pattern 93 is printed on the printing medium P by the nozzle group 33up-end of the printing head 24a and the nozzle group 33up-end of the printing head 24b. In this case, at least one or more colors of the color inks and the reactant are used for the pattern 91. As the color ink, it is preferable to use the K ink that is detected by the sensor with high accuracy; however, a color ink other than the K ink may be used. Additionally, in a case where a blur of the color ink is small, no reactant may be used for the pattern 91. On the other hand, at least one or more colors of the color inks and the reactant are used for the pattern 92 and the pattern 93. For example, only the K ink is used as the color ink. Additionally, the pattern 921 and the pattern 923 to which the application amount of the reactant than that to the pattern 922 is applied and the pattern 922 to which the application amount of the reactant more than that to the pattern 921 and the pattern 923 is applied are arranged alternately in the X direction.

### Dot Arrangement of Ink Droplet

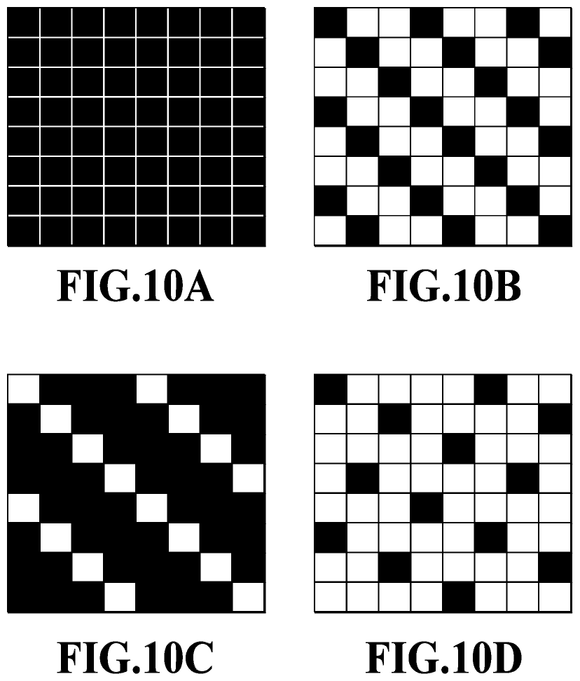

FIG. 10 is a diagram illustrating a dot arrangement example of the ink droplet in a case of printing each pattern in FIG. 9. In FIG. 10, whether the ink droplet is dropped is illustrated by using a lattice pattern including 8×8 small regions. One small region indicates the minimum unit on the printing medium P (one pixel region) in which it is possible to set whether or not to print the dot. In the example in FIG. 10, in the lattice pattern, a black region indicates the small region to which the ink droplet is dropped, and a white region indicates the small region to which no ink droplet is dropped. In FIG. 10A, there are 64 black regions out of the 8×8 small regions. In other words, FIG. 10A illustrates the dot arrangement in which the ink droplets are dropped to the 64 small regions out of the 64 small regions. In FIG. 10B, there are 22 black regions out of the 8×8 small regions. In other words, FIG. 10B illustrates the dot arrangement in which the ink droplets are dropped to the 22 small regions out of the 64 small regions. In FIG. 10C, there are 48 black regions out of the 8×8 small regions. In other words, FIG. 10C illustrates the dot arrangement in which the ink droplets are dropped to the 48 small regions out of the 64 small regions. In FIG. 10D, there are 13 black regions out of the 8×8 small regions. In other words, FIG. 10D illustrates the dot arrangement in which the ink droplets are dropped to the 13 small regions out of the 64 small regions.

The pattern 91 in FIG. 9 is a pattern printed with the K ink using the dot arrangement illustrated in FIG. 10A and the reactant using the dot arrangement illustrated in FIG. 10B. The pattern 921 in FIG. 9 is a pattern printed with the K ink using the dot arrangement illustrated in FIG. 10C and the reactant using the dot arrangement illustrated in FIG. 10D. The pattern 922 in FIG. 9 is a pattern printed with the K ink using the dot arrangement illustrated in FIG. 10C and the reactant using the dot arrangement illustrated in FIG. 10A. The pattern 923 in FIG. 9 is a pattern printed with the K ink using the dot arrangement illustrated in FIG. 10C and the reactant using the dot arrangement illustrated in FIG. 10D. In other words, a different point between the patterns 921 and 923 and the pattern 922 is the dot arrangement of the reactant. In the dot arrangement of the pattern 922, the printing density of the dot arrangement of the reactant is higher than that of the dot arrangement of the patterns 921 and 923. The pattern 931 in FIG. 9 is a pattern printed similarly to the pattern 921 in FIG. 9; for this reason, description thereof is omitted. The pattern 932 in FIG. 9 is a patter printed similarly to the pattern 922 in FIG. 9; for this reason, description thereof is omitted. The pattern 933 in FIG. 9 is a pattern printed similarly to the pattern 923 in FIG. 9; for this reason, description thereof is omitted. Note that, although the dot arrangement illustrated in FIG. 10 is used in the present embodiment, the dot arrangement different from the dot arrangement illustrated in FIG. 10 may be used depending on the printing environment.

### Waterproof Printing Medium

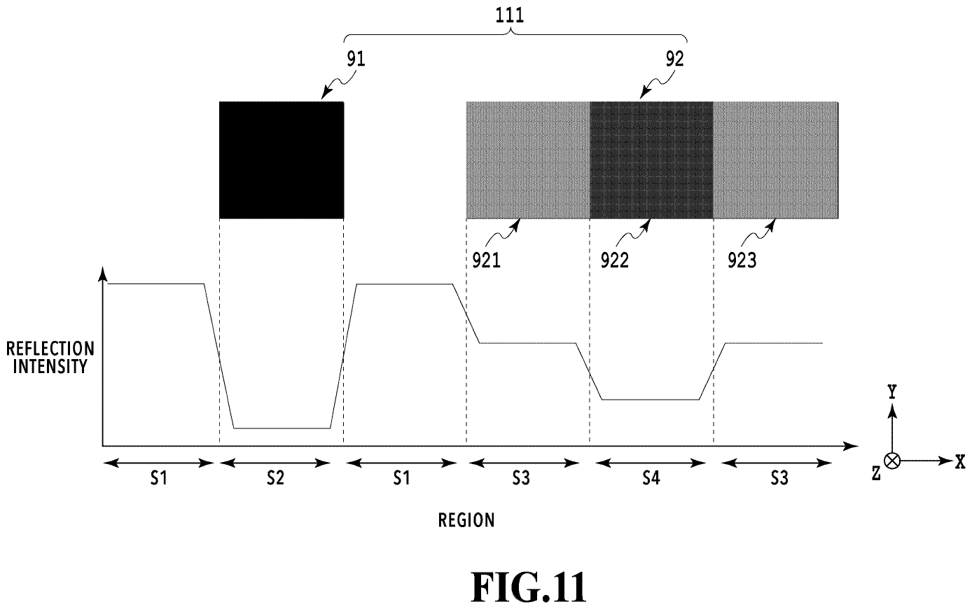

FIG. 11 is a diagram illustrating the optical characteristics in a case where the origin pattern (the pattern 91) and the adjustment pattern (the pattern 92) in FIG. 9 are printed on a gloss vinyl chloride film as an example of a waterproof printing medium. The gloss vinyl chloride film has characteristics of a low permeability and preventing the spread of the ink droplet. A pattern 111 is a pattern formed by printing the pattern 91 and the pattern 92 in the same region in the Y direction on the printing medium P by the same scanning. In FIG. 11, a non-ejection region S1 indicates a region to which no ink is ejected. Additionally, in FIG. 11, an ejection region S2, an ejection region S3, and an ejection region S4 indicate regions to which the ink is ejected. As illustrated in FIG. 11, based on a difference in the reflection intensity between the non-ejection region S1 and the reflection intensities of the ejection regions S2, S3, and S4, it is possible to detect each boundary between the ejection regions S2, S3, and S4 by the optical sensor 200 moving with the carriage in the X direction. Therefore, it is possible to specify the position of each of the ejection regions S2, S3, and S4 in the X direction. Additionally, with the adjustment pattern (the pattern 92) being printed, a different application amount of the reactant depending on the ejection region S3 and the ejection region S4 is printed. As illustrated in FIG. 9, in the adjustment pattern (the pattern 92), since the pattern 921 and the pattern 922 are adjacent to each other, and the pattern 922 and the pattern 923 are adjacent to each other, the ejection region S3 and the ejection region S4 are adjacent to each other.

In this case, the ink is printed at the same printing density in all the patterns 921, 922, and 923 according to the dot arrangement illustrated in FIG. 10C. In contrast, as for the reactant, printing is performed in the patterns 921 and 923 according to the dot arrangement illustrated in FIG. 10D, and printing is performed in the pattern 922 at a higher printing density than that of the patterns 921 and 923 according to the dot arrangement illustrated in FIG. 10A. On the waterproof printing medium, the reactant acts to increase the wettability of the ink and to increase an area factor. In this case, the area factor is a coating ratio of the ink with respect to an area of the pixel. Therefore, in a case of the waterproof printing medium, since the coating ratio of the ink with respect to an area of the pixel is increased according to an increase in the ejection amount of the reactant, the area factor is likely to be increased. Accordingly, in the region of the pattern 922 to which a relatively great amount of the reactant is applied, a higher density, that is, a lower reflection intensity is detected than that in the regions of the patterns 921 and 923 to which a relatively small amount of the reactant is applied.

Thus, according to the adjustment pattern (the pattern 92), since the ejection region S3 and the ejection region S4 have different area factors of the color ink, the reflection intensity is different between the ejection region S3 and the ejection region S4 as illustrated in FIG. 11. Therefore, based on the difference in the reflection intensity, it is possible to detect the boundary between the ejection region S3 and the ejection region S4 by the optical sensor 200. Specifically, in the ejection region S3, the application amount of the reactant ejected to each of the patterns 921 and 923 is relatively small. Therefore, the area factor of the color ink is small, and the reflection intensity has a relatively strong value. On the other hand, in the ejection region S4, the application amount of the reactant ejected to the pattern 922 is relatively great. Therefore, the area factor of the color ink is great, and the reflection intensity has a relatively weak value. Thus, since the reflection intensity of the ejection region S3 and the reflection intensity of the ejection region S4 have a gap, it is possible to detect the boundary between the ejection region S3 and the ejection region S4. In the example in FIG. 11, it is assumed that a median between the reflection intensity of the ejection region S3 and the reflection intensity of the ejection region S4 is a changing point between the reflection intensity of the ejection region S3 and the reflection intensity of the ejection region S4. Therefore, the changing point may be the boundary between the ejection region S3 and the ejection region S4. Accordingly, it is possible to specify the position of each of the ejection regions S3 and S4 based on the position of the carriage in which the optical sensor 200 detects the reflection intensity that becomes the above-described changing point. Note that, in the example in FIG. 11, it is assumed that a median between the reflection intensity of the ejection region S2 in which the origin pattern (the pattern 91) is printed and the reflection intensity of the non-ejection region S1 is a changing point between the reflection intensity of the ejection region S2 and the reflection intensity of the non-ejection region S1.

### Non-Waterproof Printing Medium

Specification of each ejection region in a case where printing is performed on the gloss vinyl chloride film is described above with reference to FIG. 11. As described above, the gloss vinyl chloride film has the characteristics of a low permeability and preventing the spread of the ink droplet. On the other hand, synthetic paper has characteristics of a low permeability and allowing for easy spread of the ink droplet. That is, the synthetic paper is one of non-waterproof printing media. It is also possible to specify each ejection region in a case of printing on the synthetic paper. On the synthetic paper, in a case where the application amount of the reactant is relatively small, the area factor is great, and the reflection intensity is weak. On the synthetic paper, in a case where the application amount of the reactant is relatively great, the area factor is small, and the reflection intensity is strong. Accordingly, it is desirable to apply the following dot arrangements to the patterns 921, 922, and 923 in order to obtain the similar optical characteristics as that in FIG. 11 and make it possible to specify the position of each ejection region.

Specifically, the pattern 921 in FIG. 9 is a pattern printed with the K ink using the dot arrangement illustrated in FIG. 10C and the reactant using the dot arrangement illustrated in FIG. 10A. A difference from the waterproof printing medium is that the non-waterproof printing medium has a higher density of the dot arrangement of the reactant. The pattern 922 in FIG. 9 is a pattern printed with the K ink using the dot arrangement illustrated in FIG. 10C and the reactant using the dot arrangement illustrated in FIG. 10D. A difference from the waterproof printing medium is that the non-waterproof printing medium has a lower density of the dot arrangement of the reactant. The pattern 923 in FIG. 9 is a pattern printed with the K ink using the dot arrangement illustrated in FIG. 10C and the reactant using the dot arrangement illustrated in FIG. 10A. A difference from the waterproof printing medium is that the non-waterproof printing medium has a higher density of the dot arrangement of the reactant.

Additionally, the pattern 931 in FIG. 9 is a pattern printed similarly to the pattern 921 in FIG. 9; for this reason, description thereof is omitted. That is, a difference from the waterproof printing medium is that the non-waterproof printing medium has a higher printing density of the dot arrangement of the reactant. The pattern 932 in FIG. 9 is a pattern printed similarly to the pattern 922 in FIG. 9; for this reason, description thereof is omitted. That is, a difference from the waterproof printing medium is that the non-waterproof printing medium has a lower printing density of the dot arrangement of the reactant. The pattern 933 in FIG. 9 is a pattern printed similarly to the pattern 923 in FIG. 9; for this reason, description thereof is omitted. That is, a difference from the waterproof printing medium is that the non-waterproof printing medium has a higher printing density of the dot arrangement of the reactant.

Note that, a use case in which the similar dot arrangement as that of the waterproof printing medium may be applied to the non-waterproof printing medium. In this use case, different optical characteristics from the optical characteristics in FIG. 11 are applied. Specifically, the reflection intensity of the ejection region S3 is weaker than the reflection intensity of the ejection region S3 in FIG. 11. The reflection intensity of the ejection region S4 is stronger than the reflection intensity of the ejection region S4 in FIG. 11. Accordingly, as with the waterproof printing medium, also in a case of the non-waterproof printing medium, the median between the reflection intensity of the ejection region S3 and the reflection intensity of the ejection region S4 may be set as the changing point between the reflection intensity of the ejection region S3 and the reflection intensity of the ejection region S4. Therefore, the changing point may be the boundary between the ejection region S3 and the ejection region S4. Accordingly, it is possible to specify the position of each of the ejection regions S3 and S4.

According to the above descriptions, it is possible to adjust the reflection intensity by changing the printing density of the dot arrangement of the reactant in either of the cases, the waterproof printing medium and the non-waterproof printing medium. Thus, as the reflection intensity can be adjusted, it is possible to detect the boundary between the patterns. Additionally, it is possible to specify the positions of the adjacent regions based on the difference in the reflection intensity between the adjacent regions. Therefore, it is unnecessary to prepare a table for computation for each printing medium P in advance.

Next, an operation of specifying the positions of the adjacent ejection regions by the above-described method in a case where the printing head 24b filled with a colorless and transparent liquid like the above-described reactant performs printing is described specifically. With the operation, it is possible to precisely obtain the amount of misalignment of the nozzle array 33 in the rotational direction (θ). In the following, details are described.

### Adjustment Method in First Embodiment

In the first embodiment, a state in which one origin pattern is applied, the ejection position of the color ink is corrected, and the ejection position of the reactant is not corrected is assumed.

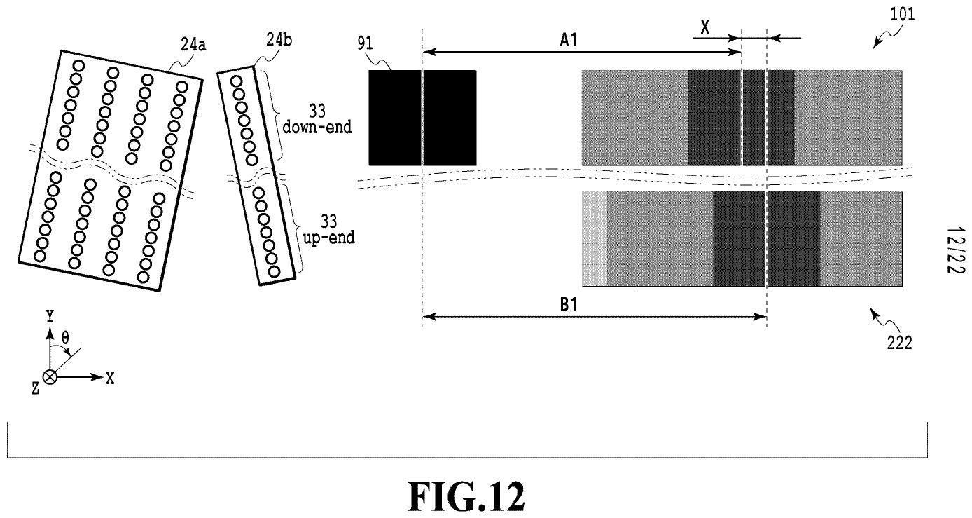

FIG. 12 is a diagram illustrating the origin pattern and the adjustment pattern on the printing medium P that are printed by the printing head 24 in FIG. 7. In FIG. 12, the pattern 91 is the origin pattern. Additionally, in FIG. 12, patterns 101 and 222 are the adjustment patterns. The printing heads 24a and 24b are mounted to be misaligned in the θ rotational direction from each other. Note that, in FIG. 12, it is assumed that the ejection position of the color ink ejected from the printing head 24a is corrected. Therefore, although corresponding two ends of the pattern 101 and the pattern 222 are aligned, a dense region of the pattern 222 is misaligned with respect to a dense region of the pattern 101 in the +X direction. That is, the dense region of the adjustment pattern (the pattern 222) is printed to be misaligned with respect to the dense region of the adjustment pattern (the pattern 101) in the +X direction. In this case, the dense region of the adjustment pattern (the pattern 222) is a region in which the reactant from the nozzle group 33up-end of the printing head 24b is printed. The nozzle group 33up-end of the printing head 24b is arrayed on the upstream end portion side of the printing head 24b. On the other hand, the dense region of the adjustment pattern (the pattern 101) is a region in which the reactant from the nozzle group 33down-end of the printing head 24b is printed. The nozzle group 33down-end of the printing head 24b is arrayed on the downstream end portion side of the printing head 24b. Note that, because of the misalignment of the printing head 24b in the θ rotational direction, the reactant is not ejected on a part of a left end region in the pattern 222, and therefore the region has a lighter color than that of another region.

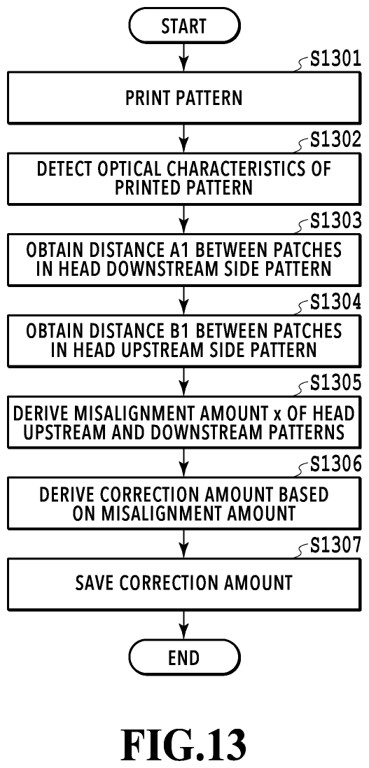

FIG. 13 is a flowchart describing processing of obtaining the θ correction amount of the printing head 24b according to the first embodiment. A series of processing illustrated in the flowchart in FIG. 13 is performed with the CPU 102 deploying a program code stored in the ROM 104 to the RAM 106 to execute. Alternatively, a part of or all the functions of the steps in FIG. 13 may be executed by hardware such as an ASIC or an electric circuit. Note that, a symbol S in the description of each processing means that it is a step in the flowchart.

In S1301, the CPU 102 performs printing of the pattern. The memory 108 stores the origin pattern and the adjustment pattern as the pattern, for example. In the processing in S1301, printing of the origin pattern and the adjustment pattern are performed as illustrated in FIG. 12. Printing of the pattern may be performed by single scanning of the carriage 22 or may be performed by multiple times of scanning without the conveyance operation. Next, in S1302, the CPU 102 detects the optical characteristics of the origin pattern and the adjustment pattern printed on the printing medium P by using the optical sensor 200 while scanning the carriage 22. The optical characteristics detected by the processing in S1302 are the optical characteristics associating the ejection position in the X direction and the reflection intensity as illustrated in FIG. 11, for example. The above-described detection is performed on each of the pattern on the downstream side of the printing head 24 and the pattern on the upstream side of the printing head 24. Specifically, in the processing in S1302, as illustrated in FIG. 11, the reflection intensity of each of the origin pattern and the adjustment pattern is detected based on the amount of received light that is received by the optical sensor 200. The reflection intensity is different depending on the application amounts of the ink and the reactant ejected to each ejection region as a measurement target. Specifically, in a case where the measurement target is the waterproof printing medium P, the higher the printing density of the dot arrangement of the reactant is, the greater the area factor, and the lower the reflection intensity. Alternatively, in a case where the measurement target is the waterproof printing medium P, the lower the printing density of the dot arrangement of the reactant is, the smaller the area factor, and the higher the reflection intensity. On the other hand, in a case where the measurement target is the non-waterproof printing medium P, the lower the printing density of the dot arrangement of the reactant is, the greater the area factor, and the lower the reflection intensity. Alternatively, in a case where the measurement target is the non-waterproof printing medium P, the higher the printing density of the dot arrangement of the reactant is, the smaller the area factor, and the higher the reflection intensity. Thus, in the present embodiment, the control unit 100 including the CPU 102 has a function of controlling the printing head 24 to print the pattern. Additionally, the control unit 100 including the CPU 102 also has a function of controlling the optical sensor 200 detecting the optical characteristics of the printed pattern.

Next, in S1303, as illustrated in FIG. 11, the CPU 102 executes the following processing based on the optical characteristics of the adjustment pattern detected by the processing in S1302. That is, the CPU 102 obtains a distance A1 between the origin pattern printed by the nozzle group 33down-end and the adjustment pattern printed by the nozzle group 33down-end. As described above, each of the origin pattern and the adjustment pattern is formed by the ink ejected from the nozzle group of the printing head 24a and the reactant ejected from the nozzle group of the printing head 24b. As described above, the difference between the origin pattern and the adjustment pattern is caused due to the difference between the printing density of the ink and the printing density of the reactant.

Next, in S1304, the CPU 102 executes the following processing based on the optical characteristics of the adjustment pattern detected by the processing in S1302. That is, the CPU 102 obtains a distance B1 between the origin pattern printed by the nozzle group 33down-end and the adjustment pattern printed by the nozzle group 33up-end. In this case, the distance obtained by each processing in S1302 and S1303 is a distance in the X direction. That is, the distance is a distance in the main scanning direction in a case where the printing unit 14 in FIG. 1 is moved in the main scanning direction along the guide shaft 20. The distance A1 is a distance between the pattern 91 and the dense region of the pattern 101. Each of the pattern 91 and the pattern 101 is printed by the multiple nozzles on the downstream end portion side. On the other hand, the distance B1 is a distance between the pattern 91 and the dense region of the pattern 222 in the main scanning direction. Each of the pattern 91 and the pattern 222 is printed by different nozzles. The pattern 91 is printed by the multiple nozzles on the downstream end portion side. The pattern 222 is printed by the multiple nozzles on the upstream end portion side. Note that, in the example in FIG. 12, the distance A1 is a distance between the center of the pattern 91 and the center of the dense region of the pattern 101; however, it is not particularly limited thereto. The distance A1 may be a distance between the center of the pattern 91 and the center of a region of a pale color being close to the pattern 91 of the pattern 101. Alternatively, the distance A1 may be a distance between the center of the pattern 91 and the center of a region of a pale color being far from the pattern 91 of the pattern 101. The distance B1 may be a distance from a portion similar to that in a case of the distance A1.

Next, in S1305, the CPU 102 derives a amount of misalignment x of the printing position of the reactant in the θ rotational direction of the printing head 24b based on the distances A1 and B1 obtained by the corresponding processing in S1303 and S1304. In this case, x is a value obtained by calculating B1−A1. That is, the amount of misalignment x of the printing position of the reactant in the θ rotational direction of the printing head 24b is positive or negative depending on the inclination direction of the printing head 24b. For example, in a case where B1−A1 is +, the pattern 222 is misaligned to the right with respect to the pattern 101. On the other hand, in a case where B1−A1 is −, the pattern 222 is misaligned to the left with respect to the pattern 101. Next, in S1306, the CPU 102 derives the correction amount of the printing position of the reactant based on the amount of misalignment x of the printing position of the reactant derived by the processing in S1305. Next, in S1307, the CPU 102 saves the correction amount derived by the processing in S1306 in the memory 108. With that, the CPU 102 ends the present processing. In a case where a new job is inputted, the ejection timing of the reactant ejected from the printing head 24b may be delayed or set ahead based on the correction amount. According to the series of operations as described above, it is possible to allow also the printing head 24b that ejects the colorless and transparent liquid like the reactant to obtain the θ correction amount thereof and to correct the ejection position on the printing medium. In a case where a new print job is inputted thereafter, based on the saved correction amount, the ejection positions of the ink and the reactant may be corrected for each print job, and printing may be performed in the corrected ejection position.

### Second Embodiment

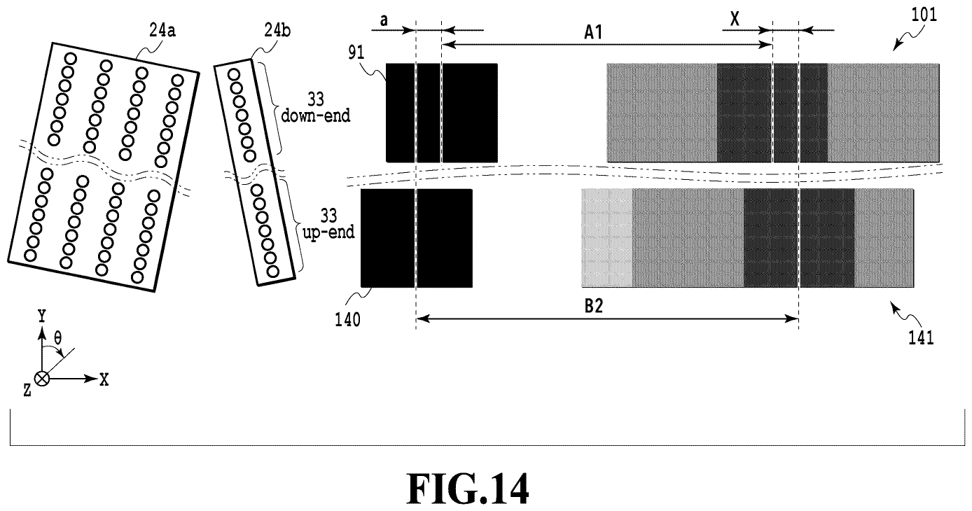

In the configuration illustrated in FIG. 2, a detection region of the optical sensor 200 in the Y direction is smaller than the printing region of the printing head 24. In this case, it is necessary to convey the printing medium P between reading of the adjustment pattern printed by the downstream end portion of the printing head 24b and reading of the adjustment pattern printed by the upstream end portion of the printing head 24b. In a case where misalignment in the X direction occurs in the above-described conveyance, it may be difficult to obtain the inclination of the printing head 24b with high accuracy. In light of the above-described problem, in the present embodiment, as illustrated in FIG. 14, the origin pattern is also printed by the nozzle group 33up-end in the upstream end portion of the printing head 24. With utilization of the origin pattern printed by the nozzle group 33up-end in the upstream end portion of the printing head 24, it is possible to detect the θ correction amount in a coordinate system of a pattern 140 that is the new origin pattern and the adjustment pattern (a pattern 141). That is, in a case of reading the pattern 140 and the adjustment pattern (the pattern 141), both the pattern 140 and adjustment pattern are affected by an conveyance error; for this reason, in a case where the pattern 141 has the same coordinate system as the coordinate system of the pattern 140 as the origin pattern, it is possible to ignore the effect of the conveyance error. Therefore, it is possible to perform processing focusing the obtainment of the θ correction amount in the coordinate system of the pattern 91 as the origin pattern and the coordinate system of the pattern 140 as the origin pattern. Accordingly, it is possible to obtain the θ correction amount with high accuracy. In the following, details are described.

### Adjustment Method of Second Embodiment

In the second embodiment, it is assumed that a value a (a amount of misalignment between the upstream side and the downstream side of the printing head 24a), which is the amount of misalignment between the origin pattern printed by the upstream end portion of the printing head 24 and the origin pattern printed by the downstream end portion of the printing head 24, is held in the printing apparatus 10 in advance. The value a is a value determined in advance due to the θ correction amount. Additionally, in the second embodiment, it is assumed that it is a state in which each ejection position of the color ink and the reactant is not corrected in a case of printing the following pattern. FIG. 14 is a diagram illustrating the origin pattern and the adjustment pattern on the printing medium P that are formed by the printing head 24 according to the second embodiment. In FIG. 14, the pattern 140 printed by the upstream end portion is added in addition to the pattern 91 printed by the downstream end portion. The pattern 140 indicates the origin pattern as with the pattern 91. Additionally, in FIG. 14, the pattern 141 is printed by the upstream end portion. As with the pattern 222 in FIG. 12, the pattern 141 indicates the adjustment pattern printed by the upstream end portion, but unlike the pattern 222, the ejection position of the color ink is not corrected. Therefore, each region of the pattern 140 and the pattern 141 in which the color ink is printed is misaligned in the −X direction. On the other hand, the upstream end portion of the printing head 24b is misaligned in the +X direction with respect to the downstream end portion of the printing head 24b. Therefore, a region in which the reactant is not ejected from the upstream end portion side of the printing head 24b and the color ink is ejected from the upstream end portion side of the printing head 24a may be formed. Additionally, as with FIG. 12, the dense region of the adjustment pattern on the upstream end portion side is misaligned in the +X direction with respect to the dense region of the adjustment pattern on the downstream end portion side. The pattern 140 in FIG. 14 is a pattern printed with the K ink using the dot arrangement illustrated in FIG. 10A and the reactant using the dot arrangement illustrated in FIG. 10B. As illustrated in FIG. 7, the printing head 24a and the printing head 24b are mounted with an inclination in the opposing direction in the θ rotational direction. Therefore, the origin pattern printed by the nozzle group 33up-end in the upstream end portion of the printing head 24a is printed to be misaligned in the −X direction with respect to the origin pattern printed by the nozzle group 33down-end in the downstream end portion of the printing head 24a. That is, the pattern 140 is printed to be misaligned in the −X direction with respect to the pattern 91. On the other hand, the dense region of the adjustment pattern printed by the nozzle group 33up-end in the upstream end portion of the printing head 24b is printed to be misaligned in the +X direction with respect to the dense region of the adjustment pattern printed by the nozzle group 33down-end of the downstream end portion of the printing head 24b. That is, the dense region of the pattern 141 is printed to be misaligned in the +X direction with respect to the dense region of the pattern 101. Additionally, strictly, although a portion with a light density to which no reactant is ejected also appears in the left end of the pattern 140, since the ejection amount of the reactant is relatively small compared to the ejection amount of the ejected ink in the pattern 140, illustration and description thereof are omitted.

Note that, the conveyance error may occur with the printing medium P being conveyed along the Y direction. In this case, in the second embodiment, the pattern 140 and the pattern 141 are detected as a set by the optical sensor 200, and the pattern 91 and the pattern 101 are detected as a set by the optical sensor 200, while the conveyance operation is performed between the detections. In other words, the optical sensor 200 detects the origin pattern and the adjustment pattern on the X direction while moving in the X direction. Thus, with the origin pattern being detected in every pattern detection, it is possible to obtain the distance between the origin pattern and the adjustment pattern in the X direction during the detection by the same scanning; for this reason, it is possible to substantially ignore the conveyance error in the Y direction considered to occur between detections. Accordingly, with the pattern according to the second embodiment, it is possible to achieve the detection of the pattern that ignores the conveyance error.

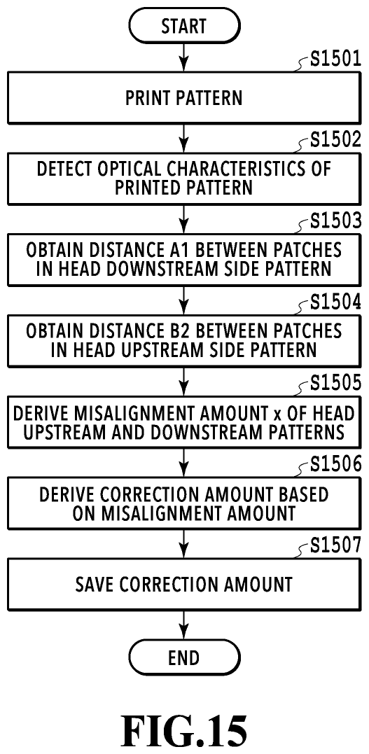

FIG. 15 is a flowchart describing processing of obtaining the θ correction amount of the printing head 24b according to the second embodiment. A series of processing illustrated in FIG. 15 is performed with the CPU 102 deploying a program code stored in the ROM 104 to the RAM 106 to execute. Alternatively, a part of or all the functions of the steps in FIG. 15 may be executed by hardware such as an ASIC or an electric circuit. Note that, a symbol S in the description of each processing means that it is a step in the flowchart.

In S1501, the CPU 102 performs printing of the pattern. The memory 108 stores the origin pattern and the adjustment pattern as the pattern, for example. In the processing in S1501, printing of the origin pattern and the adjustment pattern is performed as illustrated in FIG. 14. As with the first embodiment, printing of the pattern may be performed by single scanning of the carriage 22 or may be performed by multiple times of scanning. Next, in S1502, the CPU 102 detects the optical characteristics of the origin pattern and the adjustment pattern printed on the printing medium P by using the optical sensor 200 while scanning the carriage 22. The optical characteristics detected by the processing in S1502 are the optical characteristics associating the ejection position in the X direction and the reflection intensity as illustrated in FIG. 11, for example. The above-described detection is performed on each of the pattern on the downstream side of the printing head 24 and the pattern on the upstream side of the printing head 24.

Next, in S1503, as illustrated in FIG. 11, the CPU 102 executes the following processing based on the optical characteristics of the adjustment pattern detected by the processing in S1502. That is, the CPU 102 obtains the distance A1 between the origin pattern printed by the nozzle group 33down-end and the adjustment pattern printed by the nozzle group 33down-end.

Next, in S1504, the CPU 102 executes the following processing based on the optical characteristics of the adjustment pattern detected by the processing in S1502. That is, the CPU 102 obtains a distance B2 between the origin pattern printed by the nozzle group 33up-end and the adjustment pattern printed by the nozzle group 33up-end.

Next, in S1505, the CPU 102 derives the amount of misalignment x of the printing position of the reactant in the θ rotational direction of the printing head 24b based on the distances A1 and B2 obtained by the corresponding processing in S1503 and S1504. In this case, the misalignment x of the printing position of the reactant in the θ rotational direction of the printing head 24b is a value obtained by calculating B2−A1−a. The value a is a amount of misalignment between the origin pattern printed by the nozzle group 33down-end and the origin pattern printed by the nozzle group 33up-end. The value a is a amount of misalignment in the rotational direction of the printing head 24a. It is possible to obtain the value a by the conventional adjustment method in advance, and it is also possible to obtain the value a as the amount of misalignment between the centers of the two origin patterns. Next, in S1506, the CPU 102 derives the correction amount of the printing position of the reactant based on the amount of misalignment x of the printing position of the reactant derived by the processing in S1505. Next, in S1507, the CPU 102 saves the correction amount derived by the processing in S1506 in the memory 108. With that, the CPU 102 ends the present processing. According to the series of operations as described above, even in a case where there is an error in the X direction in the conveyance operation between reading and scanning of the adjustment pattern on the upstream side and reading and scanning of the adjustment pattern on the downstream side, it is possible to obtain the θ correction amount with high accuracy. In a case where a new print job is inputted thereafter, based on the saved correction amount, the ejection positions of the ink and the reactant may be corrected for each print job, and printing may be performed in the corrected ejection position.

### Third Embodiment

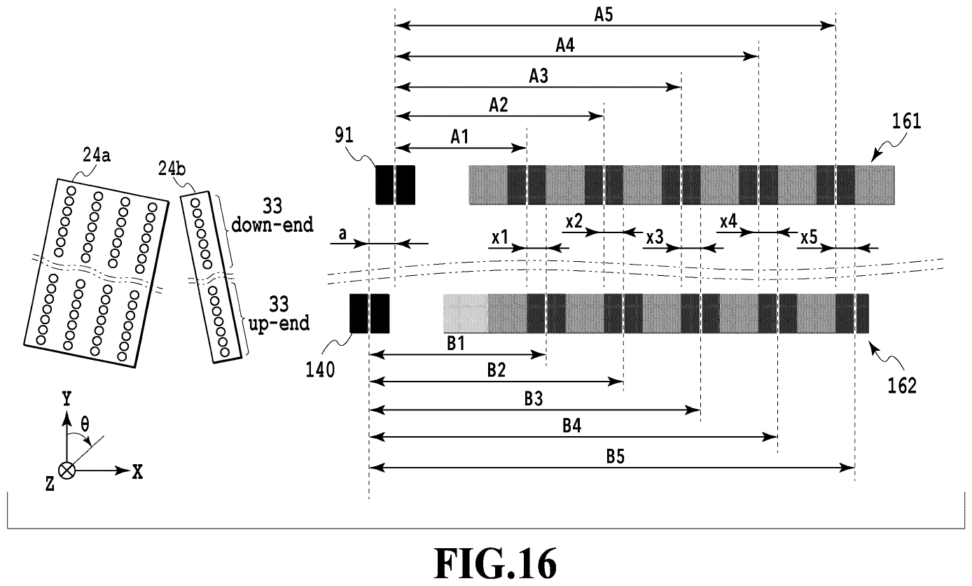

FIG. 16 is a diagram illustrating the origin pattern and the adjustment pattern on the printing medium P that are printed by the printing head 24 according to a third embodiment. In the present embodiment, the number of patches included in the adjustment pattern is increased so as to reduce the detection error of the position of the adjustment pattern and obtain the θ correction amount with high accuracy. In the following, details are described.

### Adjustment Method in Third Embodiment

In the third embodiment, it is assumed that the value a that is the amount of misalignment between the origin pattern printed by the upstream end portion of the printing head 24a and the origin pattern printed by the downstream end portion of the printing head 24 is held in the printing apparatus 10 in advance. The value a is similar to that in the second embodiment; for this reason, description thereof is omitted. Additionally, in the third embodiment, as with the second embodiment, it is assumed that it is a state in which each ejection position of the color ink and the reactant is not corrected. In FIG. 16, as with FIG. 14, the origin pattern printed by the upstream end portion of the printing head 24 is added in addition to the origin pattern printed by the downstream end portion of the printing head 24. Moreover, in FIG. 16, since the color ink is printed by the printing head 24a, the regions of the origin pattern and the adjustment pattern printed by the corresponding inks are misaligned in the −X direction. On the other hand, the upstream end portion of the printing head 24b is misaligned in the +X direction with respect to the downstream end portion of the printing head 24b. Therefore, a region in which no reactant is ejected from the upstream end portion side of the printing head 24b while the color ink is ejected from the upstream end portion side of the printing head 24a may be formed. Additionally, each of the dense regions of the adjustment pattern on the upstream end portion side is misaligned in the +X direction with respect to each of the dense regions of the adjustment pattern on the downstream end portion side. Specifically, a pattern 161 in FIG. 16 is a pattern in which multiple patterns 921 and patterns 922 in FIG. 9 are alternately arranged in the X direction. On the other hand, a pattern 162 in FIG. 16 is a pattern in which multiple patterns 931 and patterns 932 in FIG. 9 are alternately arranged in the X direction. The printing head 24a and the printing head 24b in FIG. 7 are mounted to be misaligned in the θ rotational direction. Therefore, the origin pattern printed by the upstream side of the printing head 24 is printed to be misaligned in the −X direction with respect to the origin pattern printed by the downstream side of the printing head 24. Additionally, each dense region of the adjustment pattern printed by the upstream side of the printing head 24 is printed to be misaligned in the +X direction with respect to each dense region of the adjustment pattern printed by the downstream side of the printing head 24.

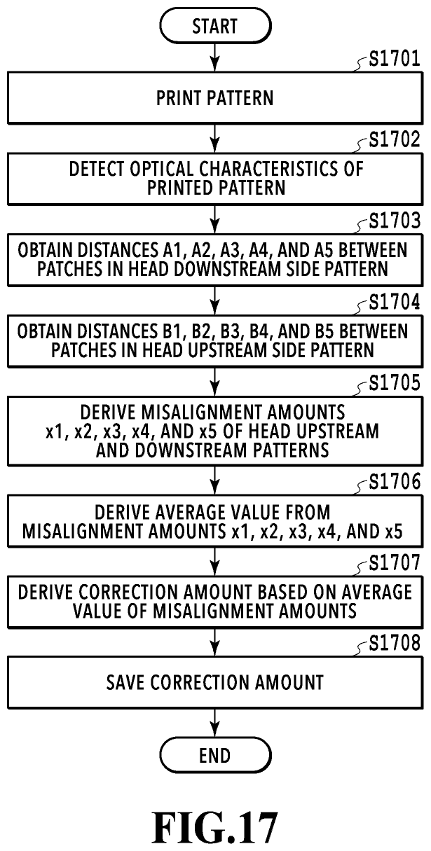

FIG. 17 is a flowchart describing processing of obtaining the θ correction amount of the printing head 24b according to the third embodiment. A series of processing illustrated in the flowchart in FIG. 17 is performed with the CPU 102 deploying a program code stored in the ROM 104 to the RAM 106 to execute. Alternatively, a part of or all the functions of the steps in FIG. 17 may be executed by hardware such as an ASIC or an electric circuit. Note that, a symbol S in the description of each processing means that it is a step in the flowchart.

In S1701, the CPU 102 performs printing of the pattern. The memory 108 stores the origin pattern and the adjustment pattern as the pattern, for example. In the processing in S1701, printing of the origin pattern and the adjustment pattern is performed as illustrated in FIG. 16. As with the above-described embodiment, printing of the pattern may be performed by single scanning of the carriage 22 or may be performed by multiple times of scanning. Next, in S1702, the CPU 102 detects the optical characteristics of the origin pattern and the adjustment pattern printed on the printing medium P by using the optical sensor 200 while scanning the carriage 22. The optical characteristics detected by the processing in S1702 are the optical characteristics associating the ejection position in the X direction and the reflection intensity as illustrated in FIG. 11, for example. The above-described detection is performed on each of the pattern on the downstream side of the printing head 24 and the pattern on the upstream side of the printing head 24.

Next, in S1703, as illustrated in FIG. 11, the CPU 102 executes the following processing based on the optical characteristics of the adjustment pattern detected by the processing in S1702. That is, the CPU 102 obtains distances A1, A2, A3, A4, and A5 between the origin pattern printed by the nozzle group 33down-end and the adjustment pattern printed by the nozzle group 33down-end.

Next, in S1704, the CPU 102 executes the following processing based on the optical characteristics of the adjustment pattern detected by the processing in S1702. That is, the CPU 102 obtains distances B1, B2, B3, B4, and B5 between the origin pattern printed by the nozzle group 33up-end and the adjustment pattern printed by the nozzle group 33up-end.

Next, in S1705, the CPU 102 obtains amount of misalignments x1, x2, x3, x4, and x5 of the printing positions of the reactant in the θ rotational direction of the printing head 24b based on the distances obtained by each processing in S1703 and S1704. In this case, x1 is a value obtained by calculating B1−A1−a, x2 is a value obtained by calculating B2-A2-a, x3 is a value obtained by calculating B3−A3−a, x4 is a value obtained by calculating B4−A4−a, and x5 is a value obtained by calculating B5−A5−a. The value a is the amount of misalignment between the origin pattern printed by the nozzle group 33down-end and the origin pattern printed by the nozzle group 33up-end. The value a is the amount of misalignment in the rotational direction of the printing head 24a. It is possible to obtain the value a by the conventional adjustment method, and it is also possible to obtain the amount of misalignment between the centers of the two origin patterns. Next, in S1706, the CPU 102 derives an average value of the amount of misalignments x1, x2, x3, x4, and x5 of the printing positions of the reactant derived by the processing in S1705. Next, in S1707, the CPU 102 derives the correction amount of the printing position of the reactant based on the average value of the amount of misalignments of the ejection positions of the reactant derived by the processing in S1706. Next, in S1708, the CPU 102 saves the correction amount calculated by the processing in S1707 in the memory 108. With that, the CPU 102 ends the present processing. According to the series of operations as described above, even in a case where the detection accuracy of the ejection position of the adjustment pattern is low, since the correction amount is derived based on the average value obtained by using the multiple dense regions, it is possible to obtain the θ correction amount with high accuracy. In a case where a new print job is inputted thereafter, based on the saved correction amount, the ejection positions of the ink and the reactant may be corrected for each print job, and printing may be performed in the corrected ejection position. Note that, in a case where one of the amount of misalignments x1, x2, x3, x4, and x5 of the ejection positions of the reactant exceeds an acceptable range set in advance, the operation panel 124 may be notified of that the nozzle of the printing head 24b has an error by an error notification. In a case where one of the amount of misalignments x1, x2, x3, x4, and x5 of the ejection positions of the reactant exceeds the acceptable range set in advance, in S1706, the average value may be derived from the amount of misalignments except that exceeding the acceptable range. For example, in a case where x5 is the amount of misalignment exceeding the acceptable range, the average value may be derived from x1, x2, x3, and x4.

### Fourth Embodiment

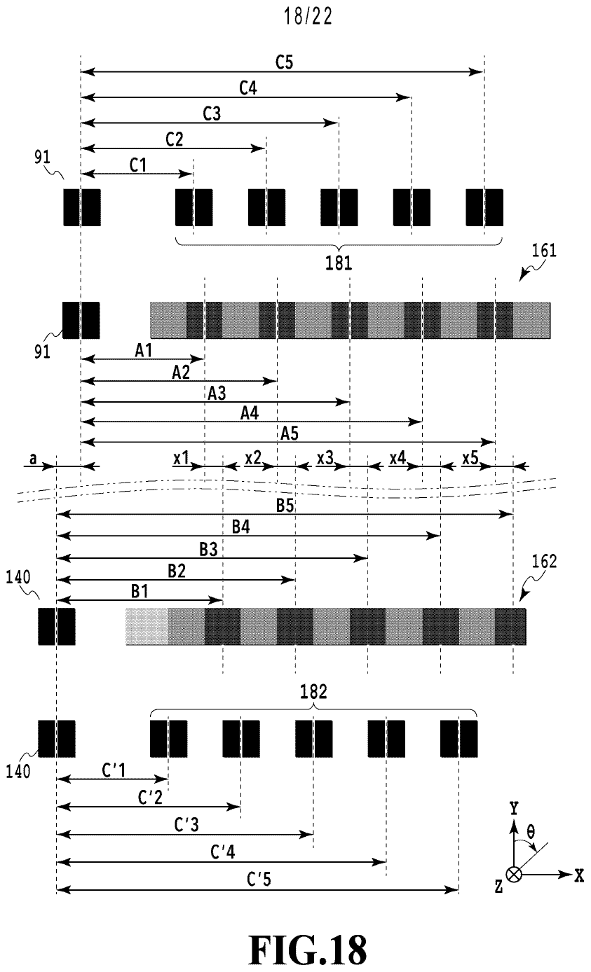

FIG. 18 is a diagram illustrating the origin pattern, the adjustment pattern, and the reference pattern on the printing medium P that are printed by the printing head 24 according to a fourth embodiment. In the present embodiment, the amount of misalignment with respect to the reference pattern is calculated for each pattern so as to reduce the error of the position of the adjustment pattern and obtain the θ correction amount with high accuracy. In the following, details are described.

### Adjustment Method in Fourth Embodiment

In the fourth embodiment, it is assumed that the value a that is the amount of misalignment of the origin pattern printed by the upstream end portion of the printing head 24 and the origin pattern printed by the downstream end portion of the printing head 24 is held in the printing apparatus 10 in advance. The value a is similar to that in the second and third embodiments; for this reason, description thereof is omitted. Additionally, in the fourth embodiment, as with the second and third embodiments, it is assumed that it is a state in which each ejection position of the color ink and the reactant is not corrected. In FIG. 18, as the reference pattern, multiple patterns similar to the origin pattern are additionally printed in the X direction. The ink color of the ink used for printing of the reference pattern is preferable to be the same as the ink color printing the origin pattern. In this case, the K ink is assumed as the reference ink. A pattern 181 is the reference pattern printed by the nozzle group 33down-end. A pattern 182 is the reference pattern printed by the nozzle group 33up-end. The pattern 161 is the adjustment pattern printed by the nozzle group 33down-end. The pattern 162 is the adjustment pattern printed by the nozzle group 33up-end. Each printing patch included in each of the reference pattern (the pattern 181) and the reference pattern (the pattern 182) is printed with the K ink using the dot arrangement in FIG. 10A and the reactant using the dot arrangement in FIG. 10B.

As illustrated in FIG. 7, the printing head 24a and the printing head 24b are mounted to be misaligned in the θ rotational direction. Therefore, the origin pattern and the reference pattern printed by the upstream end portion side of the printing head 24 are printed to be misaligned in the −X direction with respect to the origin pattern and the reference pattern printed by the downstream end portion side of the printing head 24. On the other hand, each dense region of the adjustment pattern printed by the upstream end portion side of the printing head 24 is printed to be misaligned in the +X direction with respect to each dense region of the adjustment pattern printed by the downstream end portion side of the printing head 24.

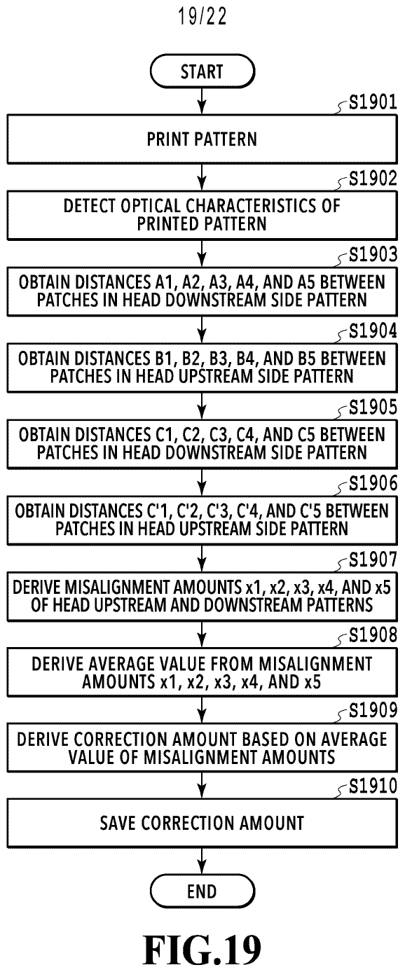

FIG. 19 is a flowchart describing processing of obtaining the θ correction amount of the printing head 24b according to the fourth embodiment. A series of processing illustrated in the flowchart in FIG. 19 is performed with the CPU 102 deploying a program code stored in the ROM 104 to the RAM 106 to execute. Alternatively, a part of or all the functions of the steps in FIG. 19 may be executed by hardware such as an ASIC or an electric circuit. Note that, a symbol S in the description of each processing means that it is a step in the flowchart.

In S1901, the CPU 102 performs printing of the pattern. The memory 108 stores the origin pattern, the reference pattern, and the adjustment pattern as the pattern, for example. In the processing in S1901, printing of the origin pattern, the reference pattern, and the adjustment pattern is performed as illustrated in FIG. 18. As with the above-described embodiment, printing of the pattern may be performed by single scanning of the carriage 22 or may be performed by multiple times of scanning. Next, in S1902, the CPU 102 detects the optical characteristics of the origin pattern, the reference pattern, and the adjustment pattern printed on the printing medium P by using the optical sensor 200 while scanning the carriage 22.

Next, in S1903, the CPU 102 executes the following processing based on the optical characteristics of the reference pattern and the adjustment pattern detected by the processing in S1902. That is, the CPU 102 obtains the distances A1, A2, A3, A4, and A5 between the origin pattern printed by the nozzle group 33down-end and the adjustment pattern printed by the nozzle group 33down-end.

Next, in S1904, the CPU 102 executes the following processing based on the optical characteristics of the reference pattern and the adjustment pattern detected by the processing in S1902. That is, the CPU 102 obtains the distances B1, B2, B3, B4, and B5 between the origin pattern printed by the nozzle group 33up-end and the adjustment pattern printed by the nozzle group 33up-end.

Next, in S1905, the CPU 102 executes the following processing based on the optical characteristics of the origin pattern and the reference pattern detected by the processing in S1902. That is, the CPU 102 obtains distances C1, C2, C3, C4, and C5 between the origin pattern printed by the nozzle group 33down-end and the reference pattern printed by the nozzle group 33down-end.

Next, in S1906, the CPU 102 executes the following processing based on the optical characteristics of the origin pattern and the reference pattern detected by the processing in S1902. That is, the CPU 102 obtains distances C′1, C′2, C′3, C′4, and C′5 between the origin pattern printed by the nozzle group 33up-end and the reference pattern printed by the nozzle group 33up-end.

Next, in S1907, the CPU 102 derives the amount of misalignments x1, x2, x3, x4, and x5 of the printing positions of the reactant in the θ rotational direction of the printing head 24b based on the distances obtained in S1903, S1904, S1905, and S1906. In this case, x1 is a value obtained by calculating (B1−C′1)−(A1−C1)−a, x2 is a value obtained by calculating (B2−C′2)−(A2−C2)−a, x3 is a value obtained by calculating (B3−C′3)−(A3−C3)−a, x4 is a value obtained by calculating (B4−C′4)−(A4−C4)−a, and x5 is a value obtained by calculating (B5−C′5)−(A5−C5)−a. The value a is the amount of misalignment in the rotational direction of the printing head 24a. It is possible to obtain the value a by the conventional adjustment method, and also it is possible to obtain the value a as the amount of misalignment between the centers of the two origin patterns. Next, in S1908, the CPU 102 derives the average value of the amount of misalignments x1, x2, x3, x4, and x5 of the printing positions of the reactant derived by the processing in S1907. Next, in S1909, the CPU 102 derives the correction amount of the printing position of the reactant based on the average value of the amount of misalignments of the printing positions of the reactant derived by the processing in S1908. Next, in S1910, the CPU 102 saves the correction amount derived by the processing in S1909 in the memory 108. With that, the CPU 102 ends the present processing. According to the series of operations as described above, the amount of misalignment of the adjustment pattern is derived by using the reference pattern printed by the nozzle group on the same side. Therefore, it is possible to further reduce the detection error of the pattern than the above-described embodiment, and even in a case where one printing head 24b is filled with only the reactant, it is possible to obtain the θ correction amount with higher accuracy. In a case where a new print job is inputted thereafter, based on the saved correction amount, the ejection positions of the ink and the reactant may be corrected for each print job, and it may be determined to perform printing in the corrected ejection position. Note that, in a case where one of the amount of misalignments x1, x2, x3, x4, and x5 of the ejection positions of the reactant exceeds an acceptable range set in advance, the operation panel 124 may be notified of that the nozzle of the printing head 24b has an error by an error notification. In a case where one of the amount of misalignments x1, x2, x3, x4, and x5 of the ejection positions of the reactant exceeds the acceptable range set in advance, in S1908, the average value may be derived from the amount of misalignments except that exceeding the acceptable range. For example, in a case where x5 is the amount of misalignment exceeding the acceptable range, the average value may be derived from x1, x2, x3, and x4.

### Fifth Embodiment

In the above-described embodiment, the method of obtaining the θ correction amount in the printing head 24b ejecting the reactant is described. For example, there is a case of the printing head that ejects only a light color ink that is detected by the optical sensor 200 with low accuracy such as a pale color magenta ink (in the following, referred to as a pale M ink). In this case, it is required to obtain the θ correction amount also in the printing head. In this case, a method of obtaining the θ correction amount in the light color ink is described. That is, a use case in which the printing head 24b is filled with the pale color ink with a relatively lower chroma than that of the ink ejected from the printing head 24a is described.

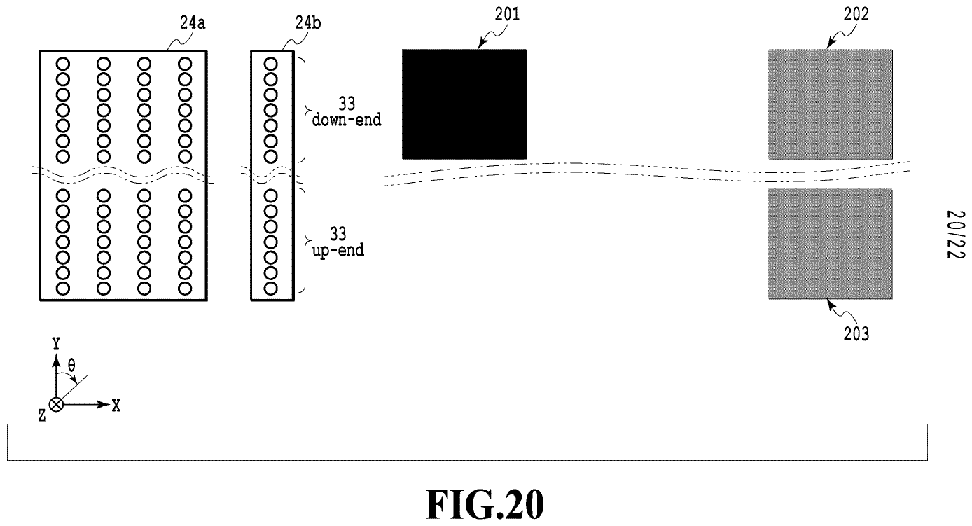

FIG. 20 is a diagram illustrating a use case in which the pattern has a low chroma. FIG. 20 is a diagram illustrating the obtainment processing to obtain the amount of misalignment of the ejection position of the color ink by using the optical sensor 200 in the adjustment method in the fifth embodiment and the pattern to be printed during the obtainment processing. A pattern 201 indicates the origin pattern printed with a normal ink. A pattern 202 and a pattern 203 each indicate the adjustment pattern printed with the pale color ink. FIG. 20 illustrates an example in which the pattern 201 and the pattern 202 are printed by the nozzle group 33down-end of the printing head 24b ejecting the pale color ink, and the pattern 203 is printed by the nozzle group 33up-end by the printing head 24b ejecting the pale color ink. As the color ink, it is preferable to use the K ink that is detected by the sensor with high accuracy; however, a color ink other than the K ink may be used. Additionally, the reactant may be applied with the color ink. One color of the pale color ink to perform adjustment is used for the pattern 202 and the pattern 203. The reactant may be applied also to the patterns. The pattern 201 is similar to the pattern 91 in FIG. 9; for this reason, description thereof is omitted. The color ink in the entire ejection region of each of the pattern 202 and the pattern 203 is printed using the dot arrangement in FIG. 10A. Although the dot arrangement in FIG. 10 is used in the present embodiment, the dot arrangement may be changed depending on the printing environment.

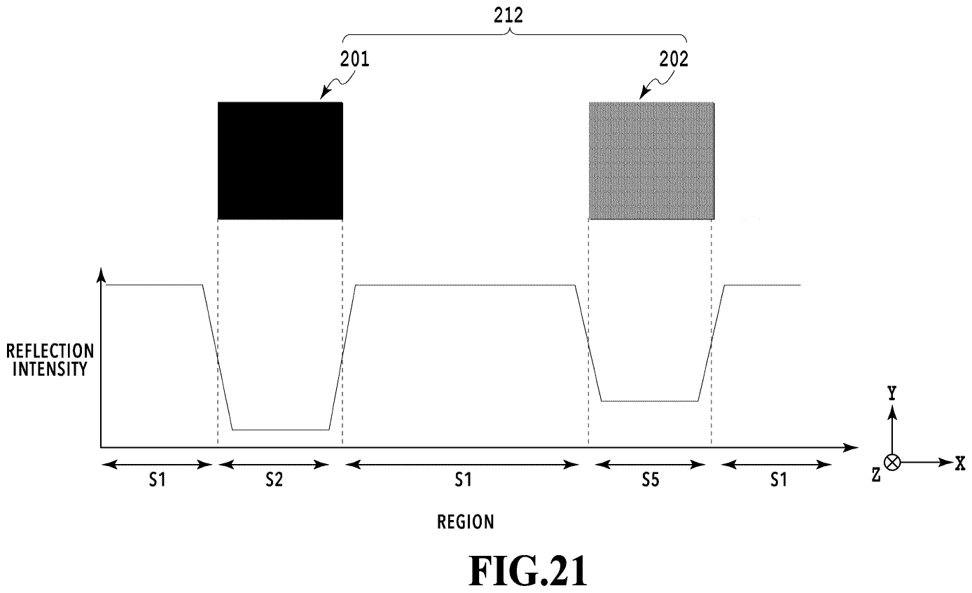

FIG. 21 is a diagram illustrating the optical characteristics of the pattern in FIG. 20. FIG. 21 is a diagram illustrating the optical characteristics in a case where the pattern in FIG. 20 is printed on the gloss vinyl chloride film. A pattern 212 indicates a pattern formed by printing the pattern 201 and the pattern 202 in the same region in the Y direction on the printing medium by the same scanning. As can be seen from the non-ejection region S1, the ejection region S2, and an ejection region S5, based on the difference in the reflection intensity between the ejection region and the non-ejection region, it is possible to detect the boundary between the regions by the optical sensor 200, and it is possible to specify the position of each ejection region. That is, with the patches of different reflection intensities being used, it is possible to detect the boundary between the regions in which the corresponding patches are printed.

### Adjustment Method in Fifth Embodiment

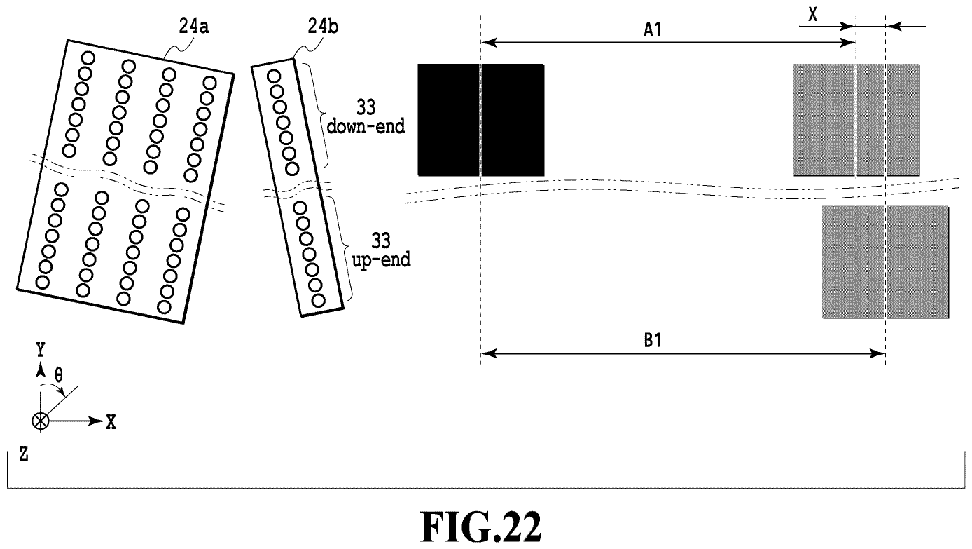

In the fifth embodiment, a state in which the printing head 24a is filled with the color ink, and the printing head 24b is filled with the pale M ink is assumed. FIG. 22 is a diagram illustrating the origin pattern and the adjustment pattern on the printing medium P in a case where the printing head 24b ejects the pale M ink as the correction target and the printing head 24b is mounted with an inclination. It is assumed that the printing position of the printing head 24a is already corrected as with the first embodiment. On the other hand, since the printing head 24b is mounted to be misaligned in the θ rotational direction, the pattern printed by the nozzle group 33up-end is printed to be misaligned in the +X direction with respect to the pattern printed by the nozzle group 33down-end. As described with reference to FIG. 21, based on the changing point of the reflection intensity, the position of each region in the X direction may be obtained, and the θ correction amount of the printing head 24b may be obtained. Therefore, according to the fifth embodiment, even in a case where one printing head 24b is filled with only the light color ink, it is possible to obtain the θ correction amount.

### OTHER EMBODIMENTS

As above, although the present disclosure is described using various examples and embodiments, the intent and the scope of the present disclosure are not limited to a specific description of the present specification. The present disclosure is not limited to the above-described embodiments, and various modifications may be applied. Additionally, the present disclosure may be an appropriate combination of parts of the embodiments described above.

### Modification 1

For example, although an example in which each processing of the present embodiment is executed by at least one of the host apparatus 114 and the control unit 100 of the printing apparatus 10, it is not particularly limited thereto. For example, at least one of the host apparatus 114 and the control unit 100 of the printing apparatus 10 may be communicable with a cloud server providing a cloud service performing various services related to the image formation. According to the above-described configuration, it is possible to execute each processing of the present embodiment in cooperation with also the cloud server in addition to the host apparatus 114 and the control unit 100 of the printing apparatus 10.

### Modification 2

Additionally, for example, in the first embodiment, an example assuming that the median between the reflection intensity of the ejection region S3 and the reflection intensity of the ejection region S4 is the changing point between the reflection intensity of the ejection region S3 and the reflection intensity of the ejection region S4 is described. With the changing point, although the position of each of the ejection regions S3 and S4 of the adjustment pattern is specified, the changing point is not limited to the median between the reflection intensity of the ejection region S3 and the reflection intensity of the ejection region S4. Desirably, the medium is 50% between the reflection intensity of the ejection region S3 and the reflection intensity of the ejection region S4. For this reason, an example in which the median between the reflection intensity of the ejection region S3 and the reflection intensity of the ejection region S4 is set as the changing point is described; however, a certain acceptable range may be provided to the medium of 50%. For example, the acceptable range may be 10% around 50%. That is, from 40% to 60% between the reflection intensity of the ejection region S3 and the reflection intensity of the ejection region S4 may be the changing point. On the other hand, although the median between the reflection intensity of the ejection region S2 in which the origin pattern (the pattern 91) is printed and the reflection intensity of the non-ejection region S1 is assumed as the changing point between the reflection intensity of the ejection region S2 and the reflection intensity of the non-ejection region S1, it is not particularly limited thereto. Since the origin pattern (the pattern 91) has contrast, the boundary between the ejection region S2 and the non-ejection region S1 is clearly expressed. Therefore, for example, in the reflection intensity of the ejection region S2, from the minimum value of the reflection intensity to the maximum value of the reflection intensity, which is 35%, may be assumed as the changing point between the reflection intensity of the ejection region S2 and the reflection intensity of the non-ejection region S1.

### Modification 3

Moreover, although the boundary between the adjacent regions is detected based on the reflection intensity obtained from the optical sensor 200 in the present embodiment, it is not particularly limited thereto. For example, based on the reflection intensity obtained by the optical sensor 200, the density of the color ink or the reactant ejected on the region may be obtained by computation, and the boundary between the adjacent regions may be detected based on the obtained density.

### Modification 4

Furthermore, although an example in which the first embodiment, the second embodiment, the third embodiment, the fourth embodiment, and the fifth embodiment are each executed individually is described in the present embodiment, it is not particularly limited thereto. For example, an embodiment that is a combination of at least two embodiments out of the first embodiment, the second embodiment, the third embodiment, the fourth embodiment, and the fifth embodiment may be applied.

For example, although a case of the two origin patterns is described in the fourth embodiment, it is not particularly limited thereto. The correction processing may be performed by using one origin pattern printed by the nozzle group 33down-end as described in the first embodiment. In other words, an embodiment that is a combination of the fourth embodiment and the first embodiment may be applied. Likewise, as an embodiment that is a combination of the third embodiment and the first embodiment, the correction processing may be performed by using the one origin pattern printed by the nozzle group 33down-end as described in the first embodiment.

### Modification 5

Additionally, although an example in which the pattern is printed by at least one of the nozzle group 33down-end of the printing head 24b and the nozzle group 33up-end of the printing head 24b is described in the present embodiment, it is not particularly limited thereto. For example, the pattern may be printed by a first nozzle group including some nozzles 32 out of the multiple nozzles 32 and a second nozzle group including some other nozzles 32 provided on the upstream side or the downstream side of the first nozzle group.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

According to the present disclosure, it is possible to precisely obtain a amount of misalignment of an ejection nozzle of a printing head, which ejects an ink with a small contrast, in a rotational direction (θ).

This application claims the benefit of Japanese Patent Application No. 2024-220161, filed Dec. 16, 2024 which is hereby incorporated by reference herein in its entirety.

What is claimed is:

1. A printing apparatus, comprising:
a printing unit configured to print a predetermined correction pattern as an image on a printing medium by scanning a first printing head and a second printing head, the first printing head including a first nozzle array having a plurality of first nozzles ejecting a first ink, the first nozzles being arrayed in a first direction, the second print head including a second nozzle array having a plurality of second nozzles ejecting a second ink with a lower density than a density of the first ink, the second nozzles being arrayed in the first direction, the image being printed while scanning the first print head and the second print head in a second direction crossing the first direction;
an obtainment unit configured to obtain an amount of misalignment of an ejection position of the second printing head in the rotational direction by detecting the correction pattern while scanning an optical sensor in the second direction; and
a derivation unit configured to derive a correction value to correct the ejection position misalignment of the second printing head in the rotational direction with respect to the first direction based on the amount of misalignment of the ejection position of the second printing head in the rotational direction, wherein
the printing unit prints an origin pattern by using the first nozzle array, prints a first adjustment pattern by using a first nozzle group of adjacent nozzles out of the plurality of second nozzles included in the second nozzle array, and prints a second adjustment pattern by using a second nozzle group of adjacent nozzles out of the plurality of second nozzles included in the second nozzle array, the second nozzle group is different from the first nozzle group, and
based on a detection result of the correction pattern, the obtainment unit obtains the amount of misalignment of the ejection position of the second printing head in the rotational direction from a difference between a distance in the second direction between an ejection position of the first nozzle array in the origin pattern and an ejection position of the second nozzle array in the first adjustment pattern and a distance in the second direction between an ejection position of the first nozzle array in the origin pattern and an ejection position of the second nozzle array in the second adjustment pattern.

2. The printing apparatus according to claim 1, wherein
the first ink contains a color material,
the second ink reacts with the first ink and changes an area factor of the first ink,
the printing unit prints the first ink by using the first nozzle array to be superimposed on a printing region of the first nozzle group in the first adjustment pattern, and prints the first ink by using the first nozzle array to be superimposed on a printing region of the second nozzle group in the second adjustment pattern, and
the obtainment unit obtains the amount of misalignment of the ejection position of the second printing head in the rotational direction based on a difference between a distance in the second direction between an ejection position of the first nozzle array in the origin pattern and a position at which the density is changed in the first adjustment pattern and a distance in the second direction between an ejection position of the first nozzle array in the origin pattern and a position at which the density is changed in the second adjustment pattern.

3. The printing apparatus according to claim 2, wherein
the origin pattern includes a first origin pattern printed in a position same as that of the first adjustment pattern in the first direction and a second origin pattern printed in a position same as that of the second adjustment pattern in the first direction.

4. The printing apparatus according to claim 3, wherein
the printing unit prints in each of the first adjustment pattern and the second adjustment pattern, two types of regions having different printing densities of the second ink alternately in the second direction, and
the obtainment unit obtains a distance from the first origin pattern to each of a plurality of positions at which the density is changed in the first adjustment pattern to obtain a first average value, obtains a distance from the second origin pattern to each of a plurality of positions at which the density is changed in the second adjustment pattern to obtain a second average value, and obtains the amount of misalignment of the ejection position of the second printing head in the rotational direction based on a difference between the first average value and the second average value.

5. The printing apparatus according to claim 3, wherein
the printing unit prints in each of the first adjustment pattern and the second adjustment pattern, two types of regions having different printing densities of the second ink alternately in the second direction, prints a third origin pattern and a first reference pattern including a plurality of patches arrayed in the second direction with respect to the third origin pattern near the first adjustment pattern by using the first nozzle array, and prints a fourth origin pattern and a second reference pattern including a plurality of patches arrayed in the second direction with respect to the fourth origin pattern near the second adjustment pattern by using the first nozzle array, and
the obtainment unit obtains the amount of misalignment of the ejection position of the second printing head in the rotational direction based on a difference between a distance from the third origin pattern to each of positions of the plurality of patches included in the first reference pattern and a distance from the first origin pattern to each of a plurality of positions at which the density is changed in the first adjustment pattern and a difference between a distance from the fourth origin pattern to each of positions of the plurality of patches included in the second reference pattern and a distance from the second origin pattern to each of a plurality of positions at which the density is changed included in the second adjustment pattern.

6. The printing apparatus according to claim 1, wherein
the first ink and the second ink contain a color material.

7. The printing apparatus according to claim 1, further comprising:
a saving unit configured to save the correction value derived by the derivation unit in a memory.

8. The printing apparatus according to claim 1, wherein
the first nozzle group is a nozzle group positioned in one end portion of the second nozzle array, and the second nozzle group is a nozzle group positioned in the other end portion of the second nozzle array.

9. The printing apparatus according to claim 1, further comprising:
a control unit configured to control an ejection timing of the second ink from the second printing head based on the correction value.

10. The printing apparatus according to claim 1, further comprising:
the optical sensor.

11. A method, comprising:
printing a predetermined correction pattern as an image on a printing medium by scanning a first printing head and a second printing head, the first printing head including a first nozzle array having a plurality of first nozzles ejecting a first ink, the first nozzles being arrayed in a first direction, the second print head including a second nozzle array having a plurality of second nozzles ejecting a second ink with a lower density than a density of the first ink, the second nozzles being arrayed in the first direction, the image being printed while scanning the first print head and the second print head in a second direction crossing the first direction;
obtaining an amount of misalignment of an ejection position of the second printing head in the rotational direction by detecting the correction pattern while scanning an optical sensor in the second direction; and
deriving a correction value to correct the ejection position misalignment of the second printing head in the rotational direction with respect to the first direction based on the amount of misalignment of the ejection position of the second printing head in the rotational direction, wherein
in the printing, an origin pattern is printed by using the first nozzle array, a first adjustment pattern is printed by using a first nozzle group of adjacent nozzles out of the plurality of second nozzles included in the second nozzle array, and a second adjustment pattern is printed by using a second nozzle group of adjacent nozzles out of the plurality of second nozzles included in the second nozzle array, the second nozzle group is different from the first nozzle group, and
in the obtaining, based on a detection result of the correction pattern, the amount of misalignment of the ejection position of the second printing head in the rotational direction is obtained from a difference between a distance in the second direction between an ejection position of the first nozzle array in the origin pattern and an ejection position of the second nozzle array in the first adjustment pattern and a distance in the second direction between an ejection position of the first nozzle array in the origin pattern and an ejection position of the second nozzle array in the second adjustment pattern.

12. A computer-readable storage medium comprising instructions that causes one or more computers to perform the steps comprising:
printing a predetermined correction pattern as an image on a printing medium by scanning a first printing head and a second printing head, the first printing head including a first nozzle array having a plurality of first nozzles ejecting a first ink, the first nozzles being arrayed in a first direction, the second print head including a second nozzle array having a plurality of second nozzles ejecting a second ink with a lower density than a density of the first ink, the second nozzles being arrayed in the first direction, the image being printed while scanning the first print head and the second print head in a second direction crossing the first direction;
obtaining an amount of misalignment of an ejection position of the second printing head in the rotational direction by detecting the correction pattern while scanning an optical sensor in the second direction; and
deriving a correction value to correct the ejection position misalignment of the second printing head in the rotational direction with respect to the first direction based on the amount of misalignment of the ejection position of the second printing head in the rotational direction, wherein
in the printing, an origin pattern is printed by using the first nozzle array, a first adjustment pattern is printed by using a first nozzle group of adjacent nozzles out of the plurality of second nozzles included in the second nozzle array, and a second adjustment pattern is printed by using a second nozzle group of adjacent nozzles out of the plurality of second nozzles included in the second nozzle array, the second nozzle group is different from the first nozzle group, and
in the obtaining, based on a detection result of the correction pattern, the amount of misalignment of the ejection position of the second printing head in the rotational direction is obtained from a difference between a distance in the second direction between an ejection position of the first nozzle array in the origin pattern and an ejection position of the second nozzle array in the first adjustment pattern and a distance in the second direction between an ejection position of the first nozzle array in the origin pattern and an ejection position of the second nozzle array in the second adjustment pattern.
